(19) United States
(12) Patent Application Publication
(10) Pub. No.: US 2026/0288761 A1
(43) Pub. Date: Sep. 24, 2026

(54) SYSTEM

(71) Applicant: SoftBank Group Corp., Tokyo (JP)

(72) Inventor: Yu SUNAGAWA, Tokyo (JP)

(73) Assignee: SoftBank Group Corp., Tokyo (JP)

(21) Appl. No.: 19/562,930

(22) Filed: Mar. 11, 2026

(30) Foreign Application Priority Data
Mar. 19, 2025 (JP) 2025-044543

(51) Int. Cl. G06F 16/28; G06N 3/0475; G06Q 40/12

(52) U.S. Cl. CPC G06F 16/285; G06Q 40/12; G06N 3/0475

(57) ABSTRACT

A system includes a processor that is configured to collect information regarding a user's income, fixed costs, and family composition, and calculate an optimal food budget based on the collected information, input a prompt sentence into a generative artificial intelligence model based on the calculated food budget to generate a home-cooked menu that is healthy and nutritionally balanced, and propose products or services based on at least one of a purchase history of the user, preferences of the user, and an emotional state of the user.

### CROSS-REFERENCE TO RELATED APPLICATION

This application is based on and claims priority under 35 USC 119 from Japanese Patent Application No. 2025-044543 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional household budgeting and meal planning tools typically treat financial planning, menu generation, and product recommendation as separate and manually intensive processes. A user is often required to calculate or estimate a food budget by themselves based on income and fixed costs, and then separately search for recipes that are both affordable and nutritionally balanced. Furthermore, conventional recommendation systems generally focus on purchase history and static preferences, and do not holistically take into account the user's current emotional state in proposing menus or related products and services. As a result, it is difficult for users to consistently maintain a healthy, cost-effective, and emotionally appropriate diet without substantial time and effort. Therefore, there is a need for a system that automatically derives an optimal food budget from user financial and household information, generates a home-cooked menu that is healthy and nutritionally balanced using a generative artificial intelligence model, and proposes products and services tailored not only to the user's purchase history and preferences but also to the user's emotional state, while optionally enabling direct ordering of ingredients via a delivery service.

### SUMMARY

In order to solve the above-described problems, according to one aspect of the present invention, there is provided a system comprising a processor, wherein the processor is configured to collect information regarding a user's income, fixed costs, and family composition, and calculate an optimal food budget based on the collected information. The processor is further configured to input a prompt sentence into a generative artificial intelligence model based on the calculated food budget to generate a home-cooked menu that is healthy and nutritionally balanced. Additionally, the processor is configured to propose products or services based on at least one of a purchase history of the user, preferences of the user, and an emotional state of the user. In some embodiments, the processor is further configured to recognize an emotion of the user and adjust at least one of the generated menu and the proposed products or services in accordance with the recognized emotion. In further embodiments, the processor is configured to enable ingredients corresponding to the generated menu to be ordered via a delivery service. By these means, the system can automatically provide an integrated solution that links financial constraints, nutritional balance, emotional responsiveness, and purchasing logistics, thereby supporting the user in maintaining a healthy and economical diet with reduced effort.

The term “system” refers to an arrangement of one or more hardware and software components, including at least one processor and associated memory, configured to execute programmed instructions to perform the functions described in the present specification and claims.

The term “processor” refers to any processing element or combination of processing elements, including but not limited to a central processing unit (CPU), a microcontroller, a digital signal processor (DSP), a graphics processing unit (GPU), or a specialized accelerator, that executes instructions to perform computations and control operations of the system.

The term “user” refers to a human individual who interacts with the system and for whom income, expenses, family composition, preferences, purchase history, and emotional state may be obtained, stored, processed, or used for generating budgets, menus, and recommendations.

The term “income” refers to monetary inflows received by the user over a specified period, such as salary, wages, bonuses, pension, or other regular or irregular payments that can be used to support the user's living expenses including food expenses.

The term “fixed costs” refers to recurring monetary outflows of the user that are relatively stable over time, such as rent, mortgage payments, utilities, insurance premiums, loan repayments, subscription fees, and similar regular obligations that reduce the amount of income available for food expenses.

The term “family composition” refers to information indicating the number of persons who share living expenses with the user and may partake in meals prepared or planned by the user, and may further include relationships, ages, or other attributes relevant to nutritional needs and meal planning.

The term “optimal food budget” refers to a monetary amount calculated by the processor, based on at least the user's income, fixed costs, and family composition, that represents a recommended allocation of funds for food expenses over a predetermined period, such as per month or per day.

The term “generative artificial intelligence model” refers to a machine learning model, such as a neural network-based generative model or large language model, that is trained using dataset(s) and configured to generate output content, including text or structured data representing menus or recipes, in response to an input prompt.

The term “prompt sentence” refers to text or other structured input data provided to the generative artificial intelligence model, which describes constraints or requirements such as budget, nutritional balance, ingredients, and user preferences, and that guides the model in generating a corresponding menu.

The term “home-cooked menu” refers to one or more meal plans or recipes that are intended to be prepared by the user or another person in a home or similar non-restaurant environment, including information about ingredients, quantities, and preparation steps. The term “healthy and nutritionally balanced” refers to a state or property of the generated menu in which the menu is designed to provide an appropriate balance of nutrients, such as carbohydrates, proteins, fats, vitamins, and minerals, in accordance with one or more dietary guidelines, nutritional standards, or rules encoded in the system.

The term “purchase history” refers to recorded information indicating past transactions or purchases made by the user, including but not limited to items purchased, purchase dates, quantities, prices, and vendors, which may be used for generating recommendations or customizing menus.

The term “preferences” refers to explicit or implicit indications of the user's likes, dislikes, and constraints with respect to food, products, services, or other items, including but not limited to favorite cuisines, ingredient exclusions, allergy information, budget sensitivity, or lifestyle choices (such as vegetarian or low-salt diets).

The term “emotional state” refers to a psychological or affective condition of the user, such as happiness, sadness, stress, fatigue, or excitement, which may be inferred or recognized based on user input, sensor data, behavioral patterns, or interaction logs, and which may be used to adjust menus or recommendations.

The term “emotion” refers to a particular type or category of the user's emotional state, such as joy, anger, anxiety, calmness, or similar affective labels, that the processor recognizes and uses as a basis for adapting menus or proposed products and services.

The term “propose products or services” refers to the operation of presenting, recommending, or ranking items, including physical goods, digital goods, and service offerings, such as food ingredients, kitchen tools, subscription services, or delivery services, to the user based on one or more of purchase history, preferences, and emotional state.

The term “adjust” refers to modifying one or more aspects of the generated menu or proposed products or services, such as changing dish types, ingredients, portion sizes, pricing emphasis, presentation order, or recommendation strength, in response to the recognized emotion or other user-related information.

The term “ingredients” refers to food items, raw materials, or consumable components used to prepare dishes in the generated menu, including but not limited to meats, vegetables, grains, seasonings, and packaged food products.

The term “delivery service” refers to a service, operated by the system provider or a third party, that receives orders for ingredients or other products and arranges for the transportation and delivery of those items to a specified location associated with the user.

The term “enable ingredients to be ordered via a delivery service” refers to providing a function by which the user can, through an interface of the system, select some or all of the ingredients corresponding to the generated menu and cause an order request for those ingredients to be transmitted to a delivery service for fulfillment.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

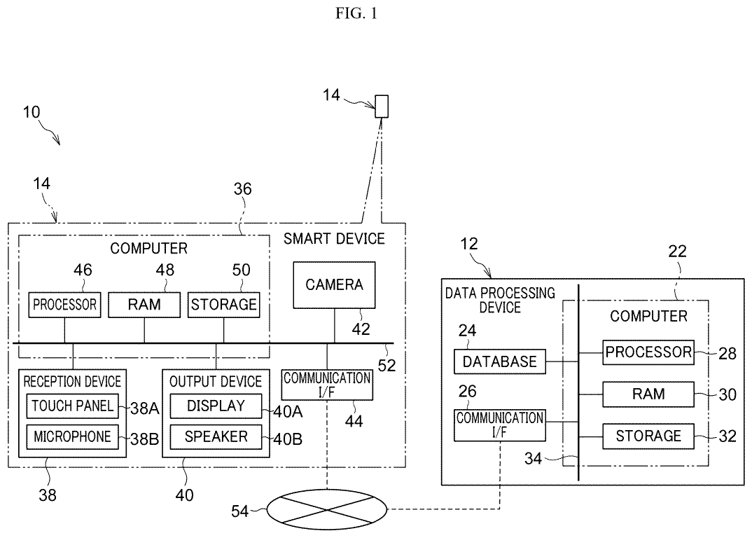

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

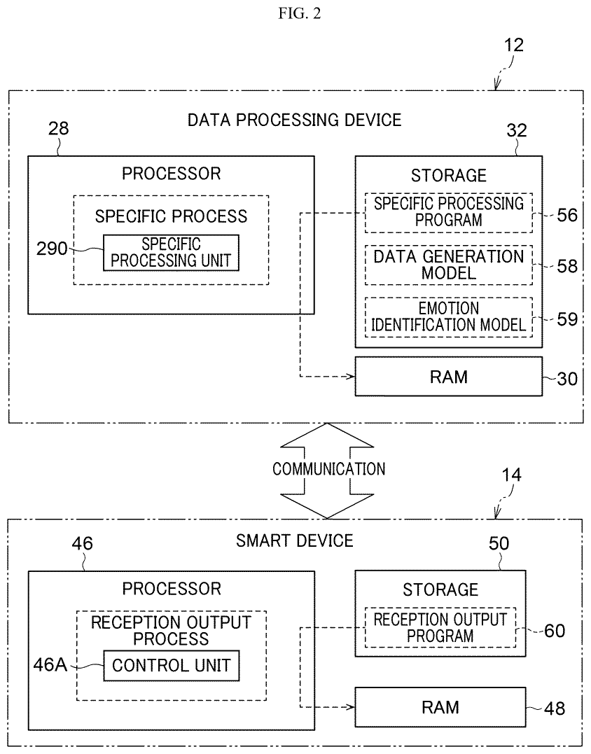

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented budgeting and recommendation systems treat financial analysis, meal planning, and product recommendation as separate, loosely coupled functions. In many existing systems, a processor merely aggregates static user profile data and applies fixed percentage rules to compute a food budget, without deeply integrating actual transaction history, household structure, and user feedback into an adaptive computational workflow. As a result, the underlying data processing architecture is not optimized for accurate, dynamic budget generation, and the system cannot reliably generate machine-usable inputs for advanced models such as generative AI models.

Further, in typical implementations, a generative AI model is invoked in an ad hoc manner, for example by manually created free-form text, and the system does not algorithmically generate structured prompt sentences based on machine-computed budget information and historical spending information. This causes variability and instability in output quality of generated menus, and prevents the processor from programmatically controlling and improving the behavior of the generative AI model over time.

In addition, conventional systems do not systematically transform raw financial transaction streams into normalized, tabular historical food expenditure information that can be re-injected into the budget computation algorithm. Computer resources are used in a naive way: transaction data is displayed to a user or stored as-is, but is not processed using dedicated tabular data processing and numerical computation programs to refine internal budget parameters. Consequently, the processor cannot automatically reconcile theoretical budgets with actual spending patterns and cannot automatically adjust subsequent computations of food budget information.

Moreover, known systems often lack a feedback-driven control loop between user interaction and the generation of prompts and menus. User evaluations, preference changes, and emotional state information, if captured at all, are typically used only for superficial filtering of recommendations. The processing apparatus is not configured to treat such information as machine learning signals that update prompt generation conditions and menu generation conditions. As a result, the internal data structures and processing flows of the system remain largely static and do not evolve to better match user behavior, leading to suboptimal utilization of computational models and external resources.

There is also a technical challenge in coordinating multiple external information processing apparatuses, such as financial data providers and delivery service platforms, with internal data processing components. Existing implementations frequently rely on isolated API calls with minimal post-processing, which leads to fragmented data and duplicated logic. The processor is not architected to integrate these external data streams into a unified, structured pipeline from acquisition of economic information, through numerical computation and tabular aggregation, to generation of prompt sentences and structured menu objects. This causes inefficiencies, increased processing latency, and difficulty in maintaining data consistency across modules.

Accordingly, there is a need for an improved computer-implemented system and method in which a processor is configured to: (i) acquire, normalize, and store user economic and household information; (ii) compute and iteratively update food budget information using numerical computation and tabular data processing programs that incorporate historical transaction data; (iii) automatically generate machine-readable prompt sentences for a generative AI model based on the computed food budget information and user-specific constraints; (iv) parse and structure AI-generated menu information into machine-usable objects; and (v) update internal generation conditions based on user feedback and emotional state information. Such an architecture can improve the technical functioning of the system by enhancing data processing efficiency, stability and controllability of generative AI outputs, and accuracy and adaptability of budget computation and recommendation logic.

The specific processing by the specific processing unit 290 of the data processing device 12 in Example 1 is realized by the following means.

The present invention provides a server comprising a processor and a storage device, the processor being configured to execute a numerical computation program and a tabular data processing program to (i) acquire user economic information, household information, financial account information, and payment instrument information via a terminal device, normalize and store the acquired information as structured data in the storage device, (ii) extract income information, expenditure information, and household composition information from the structured data, calculate disposable funds by subtracting the expenditure information from the income information using the numerical computation program, and compute food budget information based on the disposable funds and the household composition information using the tabular data processing program, (iii) obtain transaction history information from one or more external information processing apparatuses using the financial account information and the payment instrument information, process the transaction history information with the tabular data processing program to extract and aggregate dining-related transaction history as historical food expenditure information, and update the food budget information based on the historical food expenditure information, (iv) generate, by executing a prompt generation program, a prompt sentence to be input to a generative AI model based on the updated food budget information, the household composition information, and preference information and health orientation information acquired from the user, (v) provide the generated prompt sentence to the generative AI model, receive generated text representing home-cooking menu information from the generative AI model, and analyze the generated text to convert the home-cooking menu information into structured menu objects indexed by day and meal category and store the structured menu objects in the storage device, (vi) acquire evaluation information, preference change information, and emotional state information from the user regarding the structured menu objects and proposed goods and services, and programmatically update, in a learning manner, internal generation conditions used by the prompt generation program and by menu post-processing logic based on the evaluation information, the preference change information, and the emotional state information, and (vii) select, by executing a recommendation program, goods and services related to the structured menu objects based on purchase history information and the preference information, and generate proposal information including the selected goods and services for presentation to the user via the terminal device. This enables an integrated, feedback-driven computational pipeline in which the server continuously refines food budget computation and generative AI interaction, improves stability and relevance of AI-generated menus, and enhances overall system performance by tightly coupling financial data processing, prompt sentence generation, generative model invocation, and structured recommendation generation within a unified computer-implemented architecture.

The term “user” refers to an individual or entity that operates a terminal device to provide information, receive information, and interact with the system.

The term “terminal device” refers to an information processing apparatus, such as a general-purpose computer, a mobile communication device, or a network-enabled display device, that communicates with the server via a communication network.

The term “server” refers to an information processing apparatus comprising at least one processor and at least one storage device, configured to execute programs and process data received from the terminal device and external information processing apparatuses.

The term “processor” refers to one or more hardware-based processing units, such as a central processing unit or a computing core, configured to execute computer-readable instructions to implement functions of the system.

The term “storage device” refers to one or more non-transitory computer-readable media, such as a memory device or a storage unit, configured to store programs, data, and intermediate processing results.

The term “economic information” refers to information representing a financial status of the user, including at least income information and expenditure information.

The term “household information” refers to information representing a composition and characteristics of a household of the user, including at least household composition information.

The term “income information” refers to information indicating an amount of monetary inflow to the user in a predetermined period.

The term “expenditure information” refers to information indicating an amount of monetary outflow from the user in a predetermined period, including at least fixed expenditure and variable expenditure.

The term “household composition information” refers to information indicating a structure of the user's household, including at least the number of adults and the number of children.

The term “disposable funds” refers to an amount of money available for discretionary use by the user, calculated by subtracting the expenditure information from the income information.

The term “food budget information” refers to information indicating an amount of the disposable funds allocated to food-related spending for the user and the user's household.

The term “financial account information” refers to information identifying at least one financial account associated with the user in a financial institution.

The term “payment instrument information” refers to information identifying at least one payment method associated with the user, including at least a credit-based payment instrument or a debit-based payment instrument.

The term “transaction history information” refers to information indicating a plurality of financial transactions associated with the user, each transaction including at least a transaction date, a transaction amount, and a transaction category.

The term “dining-related transaction history” refers to a subset of the transaction history information that corresponds to spending on food, groceries, or dining.

The term “historical food expenditure information” refers to aggregated information representing food-related spending of the user over one or more past periods, derived from the dining-related transaction history.

The term “preference information” refers to information indicating likes, dislikes, and constraints of the user regarding meals, ingredients, goods, and services.

The term “health orientation information” refers to information indicating health-related requirements or goals of the user, including at least nutritional preferences, dietary restrictions, or target health conditions.

The term “generative AI model” refers to a machine learning model configured to generate text or other content in response to an input condition, including at least a language generation model.

The term “prompt sentence” refers to a text string representing a machine-readable instruction or query that is input to the generative AI model to cause the generative AI model to generate content according to specified conditions.

The term “home-cooking menu information” refers to information describing a set of meals that can be prepared by the user in a household environment, including at least dish descriptions and ingredient information.

The term “structured menu objects” refers to data structures representing the home-cooking menu information in a machine-usable format, the data structures being indexed by at least a time unit and a meal category.

The term “day” refers to a unit of time corresponding to a calendar day or a 24-hour period used for indexing the structured menu objects.

The term “meal category” refers to a classification of a meal within a day, including at least breakfast, lunch, and dinner.

The term “evaluation information” refers to information acquired from the user indicating a qualitative or quantitative assessment of the home-cooking menu information or of proposed goods and services.

The term “preference change information” refers to information indicating a modification of the user's preferences over time, including newly added preferences and removed preferences.

The term “emotional state information” refers to information indicating an emotional condition of the user, such as stress, satisfaction, or fatigue, obtained by explicit input or implicit detection.

The term “generation conditions” refers to parameters, rules, and constraint information used by the processor to generate the prompt sentence and to process outputs from the generative AI model.

The term “prompt generation program” refers to a program executed by the processor to construct the prompt sentence based on internal data including the food budget information, household composition information, preference information, and health orientation information.

The term “menu post-processing logic” refers to a set of procedures executed by the processor to analyze, parse, and structure generated text from the generative AI model into the structured menu objects.

The term “recommendation program” refers to a program executed by the processor to select goods and services related to the structured menu objects based on purchase history information and preference information.

The term “purchase history information” refers to information indicating past acquisitions of goods or services by the user, including at least identifiers of goods or services and acquisition times.

The term “proposal information” refers to information generated by the processor that includes a recommendation of goods or services related to the structured menu objects for presentation to the user.

The term “external information processing apparatus” refers to an information processing system outside the server, such as a financial data providing system or a delivery management system, that communicates with the server via a communication network.

The term “delivery information processing apparatus” refers to an external information processing apparatus configured to manage ordering, logistics, and delivery of goods, including at least food ingredients.

The term “ingredient information” refers to information identifying food materials required to prepare dishes included in the home-cooking menu information.

The term “delivery request information” refers to information transmitted to the delivery information processing apparatus, specifying at least ingredient information, quantities, and delivery conditions to enable delivery of corresponding goods to the user.

The term “communication function” refers to hardware and software components configured to transmit and receive data via a communication network between the server, the terminal device, and the external information processing apparatus.

The term “numerical computation program” refers to a program executed by the processor to perform arithmetic operations and numerical analysis on numerical data, including at least calculation of disposable funds and food budget information.

The term “tabular data processing program” refers to a program executed by the processor to manage and manipulate data structured in rows and columns, including at least extraction, filtering, aggregation, and transformation of financial records and household information.

In one embodiment, a server includes at least one processor, a main memory, a non-transitory storage device, and a network interface. The server executes a plurality of software components including an operating system, a web application framework, a numerical computation program, a tabular data processing program, a prompt generation program, a generative AI interaction module, a menu post-processing module, and a recommendation module. The server is connected via a communication network to one or more terminal devices operated by a user, and to one or more external information processing apparatuses such as financial data providing systems and delivery management systems.

A terminal includes a user interface device, a local processor, a local memory, and a communication interface. The terminal executes a web browser or a native application that presents input screens and result screens to the user and communicates with the server using a network protocol. The terminal may be realized by a smart phone, a tablet computer, a notebook computer, or another network-enabled computing device.

A user operates the terminal to provide economic information, household information, financial account information, payment instrument information, preference information, health orientation information, and feedback information to the server. The user also views and optionally modifies home-cooking menu information and proposal information that are transmitted from the server to the terminal.

The server executes the web application framework, for example a general-purpose framework for HTTP-based applications, to receive requests from the terminal and to return responses. The server uses a relational database management system as the storage device for structured data. The server stores, in the storage device, user profile records, household records, financial account records, transaction history records, food budget records, structured menu records, preference records, emotional state records, and recommendation records. Each record is formatted as rows and columns and may be processed as tabular data.

The server executes the tabular data processing program, which may be implemented by a high-level data frame library, to organize user data into data frames. A data frame is a tabular data structure having named columns and indexed rows. The server converts incoming JSON or form-encoded payloads from the terminal into data frames corresponding to user economic information, household information, and preference information. The server also converts API responses received from external information processing apparatuses into data frames representing transaction history information.

The server executes the numerical computation program, which may be implemented by an array-based numerical library, to perform vectorized arithmetic operations and statistical computations. For example, the server uses the numerical computation program to calculate disposable funds for each user by subtracting expenditure information from income information in a vectorized manner across an array of users. The server then calculates food budget information by applying a parameterized allocation function to the disposable funds, where the allocation function depends on household composition information such as the number of adults and the number of children.

The server uses data structures for food budget information that include at least a user identifier, a period identifier, a total budget value, and a set of derived parameters such as daily budget and per-person budget. The server stores these data structures in the storage device and also retains intermediate results for diagnostic and optimization purposes. By using vectorized operations and tabular structures, the server reduces the number of iterative loops and improves computational efficiency compared with manual or naive implementations. This yields higher throughput and lower processing latency when a large number of users are processed concurrently.

The server acquires transaction history information from external information processing apparatuses through secure communication channels. The server uses the tabular data processing program to classify each transaction into categories such as food, transportation, housing, and others. The server may apply rule-based classifiers or trained classification models that use transaction descriptions, merchant identifiers, and transaction amounts as features. The server aggregates dining-related transactions by time period using group-by operations in the tabular data processing program to generate historical food expenditure information. This aggregated information includes monthly totals, averages, variances, and other statistics that describe past food-related spending.

The server updates the food budget information by combining the theoretical allocation based on income and household composition with the historical food expenditure information. For example, the server adjusts allocation parameters if historical spending significantly deviates from the theoretical budget over multiple periods. The server uses numerical optimization methods, such as gradient-based or heuristic updates on budget parameters, to reduce the difference between recommended budgets and observed expenditures. This refinement improves the accuracy and realism of the budget values, thereby improving the downstream performance of menu planning and recommendation tasks.

The server executes the prompt generation program to construct a prompt sentence for a generative AI model. The prompt generation program uses a template structure that includes variable slots for numerical values and textual constraints. The server fills the slots with values derived from the food budget information, household composition information, preference information, health orientation information, and historical food expenditure information. The prompt generation program outputs a prompt sentence that encodes both numeric constraints and qualitative preferences in a consistent format.

In one example, the server generates a prompt sentence such as:

“With a monthly food budget of 50,000 yen for 2 adults and 2 children, please propose a healthy one-week home-cooked menu. Include breakfast, lunch, and dinner for each day, keep the total estimated ingredient cost within the budget, and consider nutritional balance, limiting processed foods and including vegetables, fish, and whole grains.”

In another example, when historical spending data and cost reduction goals are available, the server generates a prompt sentence such as:

“This family of 2 adults and 2 children has historically spent around 60,000 yen per month on food, but wants to keep the budget to 50,000 yen. Please propose a one-week home-cooked menu that is nutritionally balanced and helps reduce costs compared to their typical spending. Include concrete, affordable dishes and suggest cost-saving tips such as bulk purchasing and ingredient reuse.”

The server transmits the prompt sentence to a generative AI model that is hosted on the same server or on a remote computing system. The generative AI model may be a transformer-based neural network trained on large-scale text corpora. In one embodiment, the generative AI model includes an encoder-decoder architecture with multi-head self-attention layers, feed-forward layers, and positional encoding. The model parameters include a plurality of weight matrices and bias vectors that define attention heads and layer transformations. The generative AI model is configured to receive the prompt sentence as a sequence of tokens and to output a sequence of tokens representing menu descriptions.

The neural network of the generative AI model may be trained prior to deployment by using supervised learning with a large dataset of menu descriptions and cooking instructions. During training, the model minimizes a loss function such as cross-entropy between predicted tokens and ground-truth tokens. The model updates its weights using an optimization algorithm such as stochastic gradient descent with momentum or an adaptive gradient algorithm. The training procedure may also employ techniques such as mini-batch training, dropout, and learning rate scheduling. Data augmentation methods may be used to increase robustness, for example by paraphrasing input text or varying numeric constraints.

The server interacts with the generative AI model through a well-defined application programming interface. The server converts the prompt sentence into a tokenized representation, transmits it, receives a generated token sequence, and decodes the token sequence into a text output. The server then executes the menu post-processing module to analyze the generated text. The menu post-processing module detects structures such as day labels and meal categories (breakfast, lunch, dinner) by applying pattern matching, regular expressions, and rule-based parsing. The server extracts dish names, ingredient descriptions, and optional preparation notes and converts them into structured menu objects.

Each structured menu object may include attributes such as a day index, a meal category label, a dish identifier, an ingredient list, an estimated cost, and nutritional tags. The server stores the structured menu objects in the storage device using a normalized schema that supports efficient queries. The use of structured representations, rather than raw text, allows the server to perform further computations, such as aggregating ingredient quantities across days, checking budget coherence, and aligning menus with nutritional guidelines.

The server acquires evaluation information and preference change information from the user through the terminal. The terminal presents user interface elements that allow the user to rate dishes, specify dislikes, add dietary restrictions, or mark menus as too expensive or too complex. The server records these signals as structured data and may compute summary statistics such as average ratings per dish type or frequency of rejection for certain ingredients. The server may also acquire emotional state information explicitly (e.g., via user input) or implicitly (e.g., inferred from interaction patterns, if compliant with privacy requirements).

The server uses the evaluation information, preference change information, and emotional state information to update internal generation conditions. For example, the server maintains preference weight vectors that quantify the importance of various attributes such as ingredient type, cooking time, and recipe complexity. The server adjusts these weight vectors using learning rules inspired by gradient descent, where negatively rated items reduce weights for certain features and positively rated items increase them. The server feeds these updated weights back into the prompt generation program and into constraints applied during menu post-processing. As a result, future prompt sentences more accurately reflect the user's current preferences and emotional state, and the generative AI model's outputs are filtered and structured according to updated rules.

The server executes the recommendation module to associate goods and services with the structured menu objects. The server uses purchase history information and preference information to select candidate items such as ingredients, cooking tools, or related services. The recommendation module may compute similarity scores between menu ingredients and catalog items using vector representations of item attributes. The server then generates proposal information that lists recommended goods and services, along with links or identifiers that can be used to initiate orders.

The server communicates with a delivery information processing apparatus when the user chooses to obtain ingredients. The server compiles ingredient information from one or more structured menu objects, aggregates quantities, and formats a delivery request including product identifiers, quantities, delivery address, and desired time windows. The server transmits the delivery request information via a network protocol and receives acknowledgments or status updates. This integration with external systems creates a concrete link between abstract menu information and real-world acquisition and logistics of food materials.

The described architecture improves computer technology in several ways. By using a combination of numerical computation and tabular data processing with vectorized operations, the server reduces CPU cycles and memory overhead for budget calculation and financial data aggregation. By structuring data as data frames and normalized database tables, the server improves data locality and cache utilization, which leads to faster query responses and reduced I/O load. By generating prompt sentences algorithmically from structured budget and preference data, the server stabilizes and systematizes interaction with the generative AI model, reducing variance in outputs and enabling deterministic control over model behavior. Furthermore, the server's post-processing of AI-generated text into structured menu objects transforms unstructured outputs into machine-usable data structures, improving downstream processing and enabling error-checking and budget verification that are not feasible with free-form text alone. The feedback loop based on evaluation information and emotional state information allows the server to update internal parameters without retraining the underlying neural network, thereby enabling incremental, low-cost adaptation. This adaptive control loop is not a mere automation of human decision making; it depends on specific data structures, numerical methods, and integrated modules that optimize computing resources and enhance prediction accuracy.

The system also achieves technical effects in communication efficiency. By generating compact structured representations and transmitting only essential identifiers and aggregated quantities to external systems, the server reduces network traffic compared with transmitting full raw transaction logs or verbose free-form descriptions. The server may also cache results and reuse structured menus when conditions are similar, further reducing redundant calls to external generative AI services and cutting communication latency.

Alternative embodiments are possible. In one variation, the server hosts the generative AI model locally, executing the neural network on a graphics processing unit or a tensor processing unit. In another variation, the server uses different numerical algorithms for budget adjustment, such as robust regression or Bayesian updating. In yet another variation, the server employs different network architectures for the generative AI model, such as encoder-only transformers or recurrent neural networks, while still using structured prompt sentences and post-processing. The tabular data processing program may be replaced by another columnar data engine, and the storage device may employ different indexing schemes optimized for time-series financial data.

In all such embodiments, the server, the terminal, and the external information processing apparatuses cooperate through defined data structures, modular programs, and computational workflows. These elements collectively provide a concrete implementation that leverages generative AI models, prompt sentence generation, numerical computation, and structured data processing to achieve improved technical performance in budget computation, data management, and recommendation generation.

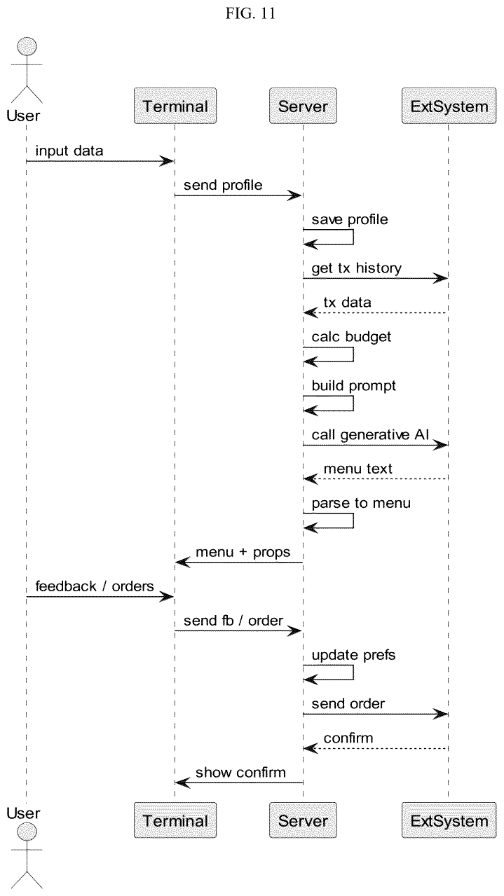

The following describes the processing flow using FIG. 11.

### Step 1:

The user operates the terminal to input economic information, household information, and preference information.

The terminal displays input fields for income, fixed expenditures, number of adults, number of children, health preferences, and dietary restrictions.

The terminal validates formats (for example, checks that income and fixed expenditures are numeric and non-negative) and converts the entered values into a structured request object.

The terminal sets a user identifier, attaches the structured input as a JSON payload, and transmits the payload to the server via a network interface using a secure protocol.

The input of this step is raw user-entered values on the terminal screen, and the output of this step is a structured, validated data packet sent from the terminal to the server.

### Step 2:

The server receives the structured data packet from the terminal via a web application framework.

The server parses the JSON payload to extract income information, expenditure information, household composition information, and preference information.

The server validates the values on the backend, for example by confirming that the sum of fixed expenditures does not exceed income and that household member counts are within plausible ranges.

The server converts the parsed values into tabular records and stores them in database tables for user profiles and household profiles.

The input of this step is the structured request object from the terminal, and the output of this step is normalized database records representing economic information, household information, and preference information.

### Step 3:

The server loads the stored user profile and household profile from the database into a tabular data processing program.

The server constructs a data frame with columns such as income, fixed_expenditure, num_adults, num_children, and preference_flags.

The server converts any string-formatted numeric fields into numerical types and fills missing values using predefined defaults.

The server computes derived fields such as total_household_size by adding the number of adults and the number of children.

The input of this step is the normalized database records, and the output of this step is a cleaned and enriched data frame ready for numerical computation.

### Step 4:

The server executes the numerical computation program to calculate disposable funds and a baseline food budget.

The server subtracts fixed_expenditure from income for each user record to obtain disposable_funds as a numerical result.

The server applies an allocation function that multiplies disposable_funds by a baseline ratio and adjusts the result according to household size and composition, thereby computing food_budget for the relevant period.

The server rounds the computed food_budget to appropriate currency units and stores the result as food budget information in the database.

The input of this step is the cleaned data frame containing income and expenditure values, and the output of this step is a set of food_budget records linked to user identifiers.

### Step 5:

The server retrieves transaction history information from external information processing apparatuses using financial account information and payment instrument information previously stored for the user.

The server calls external APIs, receives transaction records in structured form, and converts them into a transaction data frame with columns such as date, amount, merchant, and category.

The server applies categorization rules or classification models to label each transaction, then filters the data frame to keep only dining-related transactions.

The server aggregates these dining-related transactions per period, computing totals and averages to generate historical food expenditure information, which is stored in the database.

The input of this step is raw transaction history data obtained from external systems, and the output of this step is an aggregated historical food expenditure profile for the user.

### Step 6:

The server refines the food budget information by combining the baseline food_budget with the historical food expenditure information.

The server compares the historical average monthly food spending with the baseline food_budget and calculates a deviation.

The server adjusts allocation parameters, for example reducing or increasing the food_budget by a calculated percentage, to produce an updated_food_budget that better reflects realistic spending patterns and user goals.

The server writes the updated_food_budget back to the food budget records in the database.

The input of this step is the baseline food_budget and the historical food expenditure profile, and the output of this step is an updated_food_budget that will be used for subsequent menu generation.

### Step 7:

The server executes the prompt generation program to construct a prompt sentence for a generative AI model.

The server reads the updated_food_budget, household composition information, preference information, and health orientation information from the database.

The server inserts these values into a template, generating a coherent instruction in natural language.

For example, the server may generate the prompt sentence:

“With a monthly food budget of 50,000 yen for 2 adults and 2 children, please propose a healthy one-week home-cooked menu. Include breakfast, lunch, and dinner for each day, keep the total estimated ingredient cost within the budget, and consider nutritional balance, limiting processed foods and including vegetables, fish, and whole grains.”

The input of this step is structured internal data (updated food budget and user constraints), and the output of this step is a single well-formed prompt sentence string.

### Step 8:

The server sends the generated prompt sentence to the generative AI model through a generative AI interaction module.

The server tokenizes the prompt sentence, submits it to the generative AI model along with configuration parameters such as maximum output length and temperature, and waits for the model's output.

The generative AI model, implemented as a transformer-based neural network, processes the token sequence through multiple attention and feed-forward layers and outputs a sequence of tokens representing a menu description.

The server decodes the returned token sequence into text, obtaining a raw AI-generated menu text that includes day-by-day meals and ingredient lists.

The input of this step is the prompt sentence, and the output of this step is the raw textual menu description returned from the generative AI model.

### Step 9:

The server executes the menu post-processing module to convert the raw textual menu description into structured menu objects.

The server parses the text, detecting markers such as “Day 1”, “Breakfast”, “Lunch”, and “Dinner”, and segments the text accordingly.

The server extracts dish names, ingredient lists, and any indicated quantities or cooking notes, and maps these elements into structured fields such as day_index, meal_category, dish_name, and ingredient_list.

The server creates structured menu objects, stores them as records in the database, and links them to the corresponding updated_food_budget and user identifier.

The input of this step is the raw AI-generated menu text, and the output of this step is a set of structured menu objects suitable for further computation and display.

### Step 10:

The user views the structured menu information on the terminal after the terminal receives it from the server.

The terminal requests the latest structured menu objects and food budget information from the server, receives a JSON payload, and renders a calendar-like or list-based interface showing days, meal categories, dishes, and ingredients.

The user reviews each proposed dish, optionally expands details for ingredients, and indicates evaluations such as “like”, “dislike”, “too expensive”, or “too complicated”.

The terminal collects this evaluation information and any explicit preference changes (for example, “exclude pork”) and sends them to the server in a structured format.

The input of this step is the structured menu objects from the server, and the output of this step is new evaluation and preference change data generated by the user.

### Step 11:

The server receives the evaluation information, preference change information, and optionally emotional state information from the terminal.

The server updates preference records in the database, adjusting flags for disliked ingredients or adding new constraints such as “low-carb meals” or “short preparation time”.

The server computes updated preference weights by analyzing the evaluation patterns, for example lowering weights for frequently rejected ingredients and raising weights for highly rated dishes.

The server injects these updated preferences and weights into the prompt generation program and the menu post-processing constraints so that subsequent prompt sentences and structured menus more closely align with the user's behavior and state.

The input of this step is the user's feedback and emotional state signals, and the output of this step is an updated internal preference model and updated generation conditions used by later processing.

### Step 12:

The server executes the recommendation module to select goods and services related to the structured menu objects.

The server reads ingredient information and dish attributes from the structured menu objects and cross-references them with a catalog of available goods and associated services.

The server calculates relevance scores based on similarity between menu ingredients and catalog entries, and filters out items that conflict with the user's known preferences or health constraints.

The server composes proposal information that lists recommended goods and services, including identifiers and summary descriptions, and prepares this information for transmission to the terminal.

The input of this step is the structured menu objects and user preference data, and the output of this step is a ranked list of proposed goods and services.

### Step 13:

The terminal receives the proposal information from the server and displays it together with the menu information.

The terminal visually associates each proposed good or service with the corresponding dish or ingredient, for example by displaying “order ingredients” buttons next to each meal.

The user selects desired items or initiates an order request for ingredients corresponding to specific menus.

The terminal sends the user's selection as a structured order request to the server. The input of this step is the proposal information provided by the server, and the output of this step is a user-generated order request referencing specific goods and services.

### Step 14:

The server processes the order request and communicates with a delivery information processing apparatus.

The server aggregates ingredient quantities from the selected menus, resolves them into standardized product identifiers, and constructs delivery request information including item codes, quantities, delivery address, and time windows.

The server transmits the delivery request information through a communication interface to the delivery information processing apparatus and receives confirmation or error responses.

The server stores the order status in the database and sends order confirmation information back to the terminal for display to the user.

The input of this step is the user-generated order request, and the output of this step is a structured delivery request sent to an external system and an order confirmation returned to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented diet and budgeting systems typically treat budget calculation, recipe recommendation, and product ordering as separate and loosely coupled processes. In many cases, a server merely applies fixed rules to calculate a food budget from user income, and then presents static recipe suggestions without deeply integrating numerical computation, natural language generation, and external ordering workflows. As a result, such systems often fail to maintain consistency between numerical constraints (for example, disposable income and food budget) and the textual content of menu recommendations, and require substantial manual intervention by the user to translate recommendations into concrete orders for ingredients.

Furthermore, in typical systems, the generative capabilities of machine learning models are not tightly bound to structured data pipelines. Text generated by such models is often handled as unstructured output, which must be manually interpreted or heuristically parsed, leading to unreliable extraction of ingredient quantities, costs, and scheduling information. This lack of robust, automated conversion from generated text to structured purchase data prevents the system from reliably driving downstream processes such as aggregation of ingredients and automated communication with delivery services.

In addition, many existing systems do not dynamically reflect the user's emotional state, purchase history, and preferences in the generation of budget-conscious, nutritionally balanced menus. Conventional recommendation engines may adjust ranking or filtering but do not adapt the behavior of a generative AI model, including the content and constraints of a prompt sentence, based on these user signals. Consequently, the computational resources used by the server, including numerical processing and generative inference, are not leveraged to continuously improve the relevance and usability of the system's outputs for the user.

Moreover, typical food ordering integrations treat ingredient lists as simple text or manually curated items, without an automated, data-driven pipeline that maps AI-generated ingredient descriptions to concrete product identifiers and inventory states within an external delivery service. This leads to errors, broken ordering flows, or the need for human mediation whenever the AI output does not match the catalog or stock situation of the delivery service.

Accordingly, there is a need for an improved computer-implemented technique in which a server-side processor: (i) systematically transforms user-specific numerical data into a consistent food expense budget using numerical computation programs; (ii) generates and uses a structured prompt sentence to drive a generative AI model to produce budget-constrained, nutritionally balanced home-cooking menu information; (iii) automatically parses the generated text into structured data that can be reliably stored, aggregated, and used to generate purchase candidate lists; (iv) dynamically adjusts the content of prompt sentences and presentation logic based on user emotional state, preferences, and purchase history; and (v) integrates, via standardized communication interfaces, with delivery services to map structured ingredient data to available products, reflect inventory status, and maintain an end-to-end automated ordering and notification workflow. Such an approach improves the functioning of the server as a technical platform by optimizing the interaction between numerical computation, natural language generation, data structuring, and external service communication.

The specific processing by the specific processing unit 290 of the data processing device 12 in Application Example 1 is realized by the following means.

The present invention provides a server comprising a processor configured to acquire and store numerical and attribute information related to a user's income, fixed expenditures, and household composition as record information in a storage unit; execute a numerical computation program that performs matrix operations or array operations on the record information to calculate a disposable income and to numerically determine a food expense budget by applying at least one predetermined ratio or coefficient based on the household composition; generate a natural language prompt sentence including at least the food expense budget and the record information, input the prompt sentence as input data to a generative AI model, and cause the generative AI model to generate home-cooking menu information and ingredient information within a range of the food expense budget while taking nutritional balance into account; analyze text data output from the generative AI model to extract the text data as structured data including at least a menu name, temporal information, ingredient name, quantity, unit, and cost estimation information, and store the structured data in the storage unit; transmit to a user terminal display data representing a plurality of menu candidates based on the structured data, receive from the user terminal identification information corresponding to a selected menu candidate, and generate a purchase candidate list by aggregating ingredient information included in the selected menu candidate and integrating quantities for each identical ingredient; convert the purchase candidate list into a predetermined data format compatible with a communication interface of a delivery service information processing apparatus, transmit order information including the purchase candidate list to the delivery service information processing apparatus, receive an order acceptance result and delivery schedule information from the delivery service information processing apparatus, and notify the user terminal of the order acceptance result and the delivery schedule information; and acquire and store purchase history information, preference information, and emotional state information of the user, and generate proposal information by adjusting content of presentation of the home-cooking menu information or product and service information based on the purchase history information, the preference information, and the emotional state information. This enables an integrated computational workflow in which server-side numerical processing, prompt-sentence generation, generative AI inference, structured data extraction, and external service communication are cooperatively optimized, thereby improving the functioning of the computer system by automatically producing budget-consistent, context-aware menu proposals and reliably transforming them into executable ingredient orders without requiring manual intermediate steps.

The term “processor” refers to a hardware or virtual computation unit, such as a central processing unit or a programmable logic device, that executes instructions of one or more programs to perform data processing operations described in this specification and claims.

The term “storage unit” refers to a hardware or logical memory resource, such as a main memory, a non-volatile memory, or a database system, that stores record information, structured data, parameters, and program instructions used by the processor.

The term “user” refers to a human individual for whom income, expenditure, household composition, preference, and emotional state information are acquired and to whom menu information, proposal information, and order-related information are presented.

The term “income” refers to numerical information representing an amount of monetary inflow obtained by the user over a predetermined period, such as a monthly or yearly time frame.

The term “fixed expenditures” refers to numerical information representing recurring monetary outflows of the user, such as rent, utilities, and subscription fees, that are expected to be incurred regularly over a predetermined period.

The term “household composition” refers to attribute information indicating at least a number of persons belonging to a household of the user and, optionally, categories or roles of such persons, such as adults or children.

The term “record information” refers to data stored in the storage unit that includes at least numerical information and attribute information associated with the user's income, fixed expenditures, household composition, and optionally other user-related parameters.

The term “disposable income” refers to a numerical value calculated by subtracting at least the fixed expenditures from the income and representing an amount of remaining monetary resources available for discretionary use by the user.

The term “food expense budget” refers to a numerical value derived from the disposable income by applying at least one predetermined ratio or coefficient and representing an amount of monetary resources allocated for acquisition of food items for a predetermined period.

The term “numerical computation program” refers to a software component executed by the processor that performs arithmetic, matrix, or array operations on numerical data such as income, fixed expenditures, and household composition coefficients.

The term “matrix operations or array operations” refers to numerical processing techniques in which numerical values are represented as vectors, matrices, or multi-dimensional arrays and are subjected to arithmetic operations, aggregation operations, or transformation operations.

The term “prompt sentence” refers to a natural language text sequence that includes at least the food expense budget and record information and that is provided as input data to the generative AI model to condition or control the model's generation behavior.

The term “generative AI model” refers to a machine-learned model, such as a neural network-based text generation model, that receives the prompt sentence as input and outputs generated text representing at least menu information, ingredient information, or proposal information.

The term “home-cooking menu information” refers to information generated or stored by the system that describes one or more meal plans that can be prepared by the user, including dish names and, optionally, preparation times, cooking methods, and scheduling information.

The term “ingredient information” refers to information associated with a home-cooking menu, including at least names of food items, required quantities, and units necessary to prepare the corresponding menu.

The term “nutritional balance” refers to compliance with or consideration of one or more nutritional criteria, such as energy, protein, fat, carbohydrate, vitamin, or mineral balances, when generating or evaluating menu information.

The term “text data” refers to machine-readable character sequences output by the generative AI model, including natural language sentences, structured text fragments, or delimited fields that describe menus, ingredients, or costs.

The term “structured data” refers to data obtained by analyzing and converting text data into a format with explicitly defined fields, such as menu name, temporal information, ingredient name, quantity, unit, and cost estimation information.

The term “temporal information” refers to data indicating a time-related attribute of a menu, such as a date, a day of the week, a meal time, or a time period over which the menu is planned.

The term “cost estimation information” refers to data indicating an estimated monetary cost associated with preparing a menu or acquiring its corresponding ingredients.

The term “display data” refers to data generated by the processor and transmitted to a user terminal, which enables presentation of menu candidates, proposal information, order status, or delivery status on a display device.

The term “menu candidate” refers to a single instance of home-cooking menu information selected or selectable by the user from a plurality of menus presented by the system.

The term “identification information” refers to data that uniquely or specifically indicates a selected menu candidate, such as an identifier, index, or key, which is transmitted from the user terminal to the server.

The term “purchase candidate list” refers to an aggregated list of ingredients derived from one or more selected menu candidates, in which quantities of identical ingredients are combined to represent total required amounts for ordering.

The term “communication interface” refers to a logical or physical interface, such as an application programming interface or network endpoint, through which the processor exchanges data with an external information processing apparatus of a delivery service. The term “order information” refers to data transmitted to the delivery service information processing apparatus that includes at least the purchase candidate list and may include delivery address information, user identification, payment-related information, and delivery preferences.

The term “order acceptance result” refers to data received from the delivery service information processing apparatus indicating whether the order information has been accepted, partially accepted, or rejected, and optionally including an order identifier.

The term “delivery schedule information” refers to data indicating a planned delivery time, delivery date, or delivery time range for ordered items as provided by the delivery service information processing apparatus.

The term “purchase history information” refers to data representing one or more past purchases or orders made by the user, including items, quantities, dates, and possibly costs.

The term “preference information” refers to data representing explicit or implicit preferences of the user, such as favored food types, disliked ingredients, dietary restrictions, or cooking style preferences.

The term “emotional state information” refers to data indicating an estimated affective condition of the user, such as stress level, satisfaction, or mood, inferred from input signals or explicitly provided by the user.

The term “proposal information” refers to information generated by the processor that includes menu recommendations, product suggestions, or service suggestions adjusted according to at least one of the purchase history information, preference information, and emotional state information.

The term “utterance information” refers to data representing spoken input obtained from the user via an audio input device and, optionally, converted into text by a speech recognition process.

The term “input character information” refers to textual data directly entered by the user through an input device, such as a keyboard, touch panel, or software input interface.

The term “operation history information” refers to data representing the user's past interactions with a user terminal or application, including selection operations, navigation actions, and response times.

The term “filtering or weighting” refers to processing in which candidate items, such as menu information or product and service information, are selectively included, excluded, or ranked according to scores, thresholds, or coefficients derived from the emotional state information, preference information, or purchase history information.

The term “delivery service information processing apparatus” refers to an external computer system operated by a provider of product delivery services, which receives order information, manages product inventory, and provides order acceptance results and delivery schedule information.

The term “product identification information” refers to data representing a unique or standard identifier of a product managed by the delivery service information processing apparatus, such as a code, catalog number, or stock-keeping unit.

The term “inventory information” refers to data representing availability, stock quantity, or stock status of products managed by the delivery service information processing apparatus.

The term “product information” refers to data representing attributes of items available through the delivery service, including at least product identification information, descriptions, package sizes, and possibly price information.

The term “order status” refers to data indicating a current processing state of an order within the delivery service, such as pending, confirmed, being prepared, shipped, or completed.

The term “delivery status” refers to data indicating the current logistics state of an ordered item, such as in transit, out for delivery, or delivered.

In one embodiment, a server includes a processor, a main memory, a non-volatile storage device, and a network interface. The server executes an operating system such as a general-purpose server operating system and a middleware stack including a web application framework, a numerical computation library, a data analysis library, and a machine learning library. The server is connected via a communication network to one or more terminals. Each terminal includes a display device, an input device, a communication module, and a browser or native application. A user operates the terminal to interact with the server.

The server executes application software implemented, for example, on a web application framework such as a server-side framework, a data analysis library such as a tabular data processing library, a numerical computation library such as a multidimensional array computation library, and a machine learning framework such as a tensor computation framework. These software components run as processes or threads and cooperate via defined data structures and function calls.

The server acquires user profile information through a user interface presented on the terminal. The server presents, via the browser or native application of the terminal, input fields for income, fixed expenditures, and household composition. The terminal displays web pages or application screens rendered by the server and sends user-entered values to the server through secure network communication. The user inputs numerical values representing income (for example, a monthly salary), fixed expenditures (for example, recurring payments), and household composition (for example, number of adults and children). The terminal transmits these values as structured messages, such as form-encoded or serialized numerical and categorical fields.

The server stores the received profile information in a storage unit. The server uses a database management system, such as a relational database, to maintain tables for user profiles, menu plans, ingredient lists, orders, and model interaction logs. The server maps each user to a record that includes numeric fields (income, fixed expenditure amounts, household size) and categorical fields (household member categories, dietary preferences). The data is stored in normalized tables with keys and indexes, which improves query performance when retrieving records for numerical computation and model input.

The server uses a numerical computation library to compute a disposable income and a food expense budget from the stored profile information. The server loads relevant records into in-memory data structures such as data frames, which internally maintain columns as typed arrays. The server converts the income and fixed expenditure columns into multidimensional array objects. The server calculates disposable income by subtracting, in a vectorized operation, the fixed expenditures from the income. The server then multiplies the disposable income by a configurable ratio (for example, 0.4 to 0.6) to determine a base food budget. The server further adjusts the base food budget by applying household-related coefficients, such as different weights for adults and children. Because these calculations are implemented as vectorized array operations, the server reduces the number of interpreter-level loops, which improves calculation speed and reduces CPU cache misses compared with scalar or purely rule-based implementations.

The server generates a prompt sentence for a generative AI model by combining the computed food expense budget with the profile information and with additional constraints. The server constructs a natural language string including fields such as the monthly income, fixed expenditures, household composition, desired number of days, and nutritional balance constraints. The server may, for example, generate a prompt sentence of the form:

“The user has a monthly income of 300,000 units, fixed expenditures of 100,000 units, and a household of 3 people. Propose an optimal food budget allocation and a 7-day home-cooking menu plan within a 50,000-unit monthly food budget, ensuring balanced nutrition across protein, carbohydrates, fats, and vegetables.”

The server may also generate alternative prompt sentences including user preferences or time constraints, such as:

“For a family of 3 with a food budget of 50,000 units, generate healthy, low-cost dinner menus for one week, including ingredient lists, quantities, and approximate prices for each dish.”

“The user has 40,000 units remaining for food this month and lives with 2 adults and 1 child. Generate Japanese-style daily menus that fit this budget, limit cooking time to 30 minutes per day, and avoid high-sodium ingredients.”

The server inputs the constructed prompt sentence into a generative AI model implemented on a tensor computation framework. In one embodiment, the generative AI model is a sequence-to-sequence neural network with a Transformer architecture including an encoder and a decoder. The server stores model parameters as tensors (for example, weight matrices and bias vectors) in the storage unit and loads them into main memory during inference. The encoder receives tokenized prompt sentences, which are converted into numerical token identifiers using a tokenizer. The encoder comprises multiple layers of multi-head self-attention and feedforward sublayers, each using learned weight matrices and non-linear activation functions. The decoder receives shifted output tokens and attends both to decoder self-attention states and encoder outputs, thereby generating probability distributions over the vocabulary for each time step.

The server uses a trained parameter set that has been obtained beforehand through supervised training on a corpus of recipe texts, ingredient lists, and annotated budgets. During training, the server (or an off-line training system) minimizes a loss function such as cross-entropy between predicted token probabilities and ground-truth tokens, using an optimization algorithm such as stochastic gradient descent with adaptive learning rate. The training process updates the weight tensors by computing gradients via backpropagation through the network and applying weight updates to minimize the loss. The training data may include features derived from historical menus, nutritional labels, and cost annotations, so that the resulting model learns correlations between ingredient combinations, cost patterns, and nutritional compositions.

The server improves generative quality and technical performance by incorporating budget-related features into the encoding process. For example, the server embeds the computed food expense budget, the household size, and a target per-meal cost as additional numeric features. The server either encodes these as special tokens appended to the prompt sentence or feeds them as auxiliary vectors concatenated to the token embeddings. This structure allows the model to learn an internal representation that aligns text generation with numeric cost constraints, reducing the discrepancy between recommended menus and feasible budgets and thereby reducing the need for post-processing corrections.

The server performs inference by running the generative AI model on dedicated hardware, which may include a graphics processing unit or a specialized accelerator. The server selects decoding parameters such as beam width, maximum token length, and temperature. For example, the server uses beam search with a beam width greater than one and a length penalty to balance diversity and coherence of generated menus. The server may also apply constraints during decoding, such as prohibiting certain ingredients or enforcing the total estimated cost per day not to exceed a threshold encoded in the prompt sentence.

The server receives generated text from the generative AI model as sequences of tokens that are converted into characters and words. The generated text includes menu titles, daily or weekly schedule labels, ingredient names, quantities, units, and estimated costs. The server then parses this text to construct structured data. The server employs deterministic parsing rules and pattern matching, such as regular expressions and delimiter-based segmentation, to identify headings (for example, “Day 1:”), dish names, and ingredient lines. For ingredients, the server separates quantity, unit, and ingredient name by detecting numeric substrings and recognized measurement units (for example, grams, pieces, cups).

The server stores the structured data in database tables, such as a menu plan table and an ingredient table. Each menu record includes a unique identifier, menu name, associated date or time period, and total estimated cost. Each ingredient record is linked to a menu record and includes an ingredient name, quantity, unit, and cost estimate. The structured representation enables indexed retrieval of menus and ingredients and allows efficient aggregation across multiple menus. Because the server converts the free-form generative output into standardized, typed fields, the subsequent numerical and communication processing becomes more robust and predictable compared with manual or ad-hoc handling of text.

The terminal receives menu candidate data from the server and presents it to the user. The terminal displays each menu with its title, daily cost, and a summary of main ingredients. The user selects one or multiple menus that are acceptable. The terminal sends the selection, encoded as menu identifiers, to the server. The server uses tabular data structures to load the ingredient records corresponding to the selected menus and executes aggregation operations. The server groups ingredient rows by ingredient name and unit, then sums quantities to obtain total required amounts across all selected menus. This aggregation is implemented as columnar operations on in-memory tables, which improves runtime efficiency compared with row-by-row processing, particularly when the number of menus or ingredients becomes large.

The server subsequently maps the aggregated ingredient list to actual products managed by a delivery service. The server maintains a mapping table between normalized ingredient names and product identifiers of the delivery service. The server also acquires inventory information from the delivery service system via an application programming interface. In one embodiment, the server periodically requests product catalogs and stock levels from the delivery service and caches the results. When generating order information, the server searches, for each ingredient, candidate products that match the normalized name and meet quantity and package size constraints. The server selects specific product identifiers based on preferences (for example, brand, organic flag) and cost optimization logic. The mapping process uses similarity measures between ingredient names and product names and may use rule-based normalization (for example, converting plural forms to singular, mapping synonyms).

The server then encodes the order as structured order information compatible with the communication interface of the delivery service. The order information includes product identifiers, quantities, user address, delivery time window, and payment-related identifiers. The server sends the order information through a network interface using a standardized protocol such as HTTP over TLS with a defined message format. The delivery service system returns an order acceptance result, such as a confirmation or a partial acceptance with substitutions, and delivery schedule information, including estimated delivery time or date. The server stores this information in the storage unit and sends a summary to the terminal, where the user can confirm or modify the order.

The server also acquires user emotional state information, preference information, and purchase history information. The terminal may provide utterance information obtained via a microphone and converted into text by speech recognition, input character information entered by the user, and operation history information such as menu selection patterns, time spent viewing items, and cancellation events. The server executes an emotion estimation module that analyzes text and interaction patterns. For example, the server uses a neural network classifier that takes as input word embeddings of recent textual inputs and aggregated statistics of operation history (such as frequency of menu rejections) and outputs probabilities of predefined emotional categories (for example, stressed, satisfied, tired). The classifier may be implemented as a bidirectional recurrent network or a Transformer encoder trained on annotated emotional corpora. The server updates a user emotion profile stored in the storage unit.

The server uses the emotional state information to modify the prompt sentence and to filter or re-rank generated menus. For example, when the server detects that the user is stressed or tired, the server may append instructions to the prompt sentence such as “limit preparation time to under 20 minutes and reduce complexity of recipes.” When the server detects that the user is satisfied and exploratory, the server may encourage more diverse or elaborate menus in the prompt sentence. By systematically altering the prompt sentence and constraints based on structured emotional state data, the server enables the generative AI model to produce output aligned with the user's current situation, thereby reducing the need for the user to manually adjust filters or respecify requirements.

The server improves technical performance by maintaining the prompt generation and parsing pipeline as reusable, parameterized components. Prompt templates are stored as structured objects with placeholders for numeric values (such as budget and household size) and for dynamic constraints (such as maximum preparation time and forbidden ingredients). The server fills these placeholders using the numerical computation results and user state. This architecture enables the server to rapidly generate prompt sentences without repeated string concatenation logic and ensures consistency between the data fields and the textual description. The consistent prompt design, in turn, stabilizes the distribution of inputs to the generative AI model, which improves generation stability and adherence to constraints and reduces computation wasted on infeasible or irrelevant outputs.

The server's pipeline also improves the functioning of the computer system by integrating vectorized numerical computation, constrained generative modeling, structured parsing, and external system communication in a single optimized flow. The use of array-based operations and batch processing in the numerical and aggregation stages reduces memory transfers and function call overhead compared with naive scalar loops. The tight coupling between budget calculation and generative conditioning (via the prompt sentence) reduces the number of iterations needed to obtain a set of acceptable menus, which reduces overall inference load and network traffic between the server and the terminal. The structured data extraction step allows the server to store menus and ingredients in normalized tables, which improves indexing and query efficiency for subsequent user sessions and allows caching and reuse of previously generated menus.

The server can implement alternative embodiments of the generative AI model. In one alternative, the server uses an encoder-decoder architecture trained with reinforcement learning to optimize explicit objectives such as cost deviation from target budget and nutritional score. The server defines a reward function that penalizes menus whose estimated total cost deviates from the food expense budget and menus that violate dietary constraints. During training, the server samples menus from the model, evaluates them using the reward function, and updates model parameters using policy gradient methods. This configuration improves alignment between generated menus and numeric constraints beyond simple supervised learning, enhancing the precision of budget adherence and nutritional balance.

In another embodiment, the server uses a modular architecture in which a first neural network generates candidate dishes without cost constraints, and a second network or algorithm assigns these dishes into daily plans and adjusts selections based on budget and nutritional scoring. The server calculates nutritional metrics from ingredient lists using a nutrient database and computes a composite score. The server then performs combinatorial optimization, such as greedy search or integer programming, to select a subset of generated dishes that satisfies cost and nutritional constraints. This modular design can further reduce the need for repeated large-scale generative inference when only budget constraints change, improving computation efficiency.

The terminal can be implemented as a smartphone, tablet, or personal computer. The terminal executes a browser or dedicated application that renders menus, prompts, and order confirmations based on data received from the server. The terminal may locally cache recent menu data and images to reduce network load and improve perceived responsiveness. The user may provide feedback, such as ratings or comments, which the terminal transmits to the server. The server analyzes this feedback to refine preference models and adjust future prompt sentences and ranking algorithms, thereby improving the technical performance of the recommendation pipeline over time.

The described system is not limited to food and menu planning. In another variation, the server applies the same architecture to other resource allocation contexts, such as healthcare regimen planning or recurring subscription optimization, in which numeric budgets, user states, and generative text outputs must be coordinated. In each case, the server uses a similar combination of vectorized numeric computation, generative AI models driven by carefully constructed prompt sentences, deterministic parsing into structured data, and communication with external systems that enact the generated plans. This generic yet technically specific architecture improves the functioning of the computer platform in terms of processing speed, accuracy of constraint satisfaction, robustness of downstream execution, and reduced need for manual interpretation of machine-generated content.

Through these configurations, the server, the terminal, and the user cooperate in an integrated computational environment in which numerical budgeting, generative AI-based planning, and external service coordination are implemented as concrete technical processes. The system thereby provides improved data management, calculation efficiency, and communication control, going beyond mere automation of human planning and ordering tasks and instead enhancing the operation of the underlying computer technology.

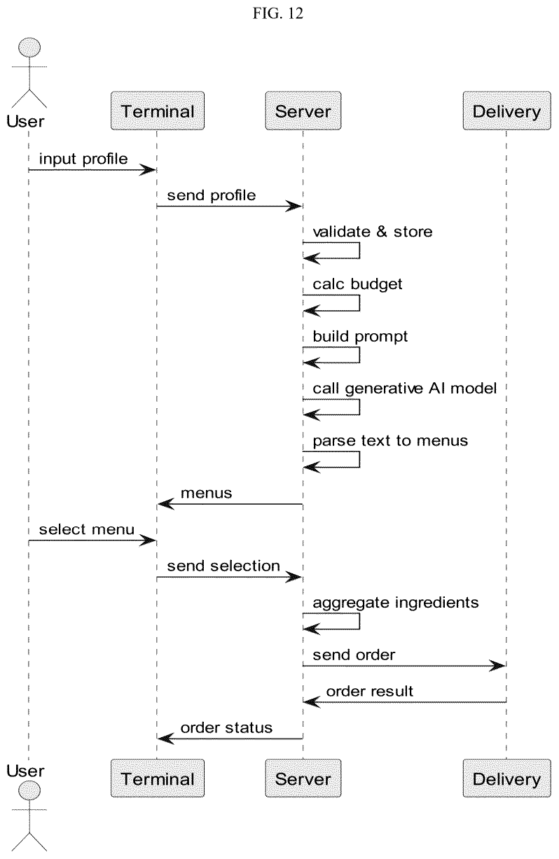

The following describes the processing flow using FIG. 12.

### Step 1:

User operates the terminal and inputs profile data including income, fixed expenditures, and household composition into input fields displayed on a screen.

The input of this step is raw numeric and categorical values entered by the user (for example, income amount, rent amount, number of household members), and the output is a set of structured profile parameters temporarily held in the terminal's memory.

Terminal collects the values from the input fields, validates basic formats locally (for example, checking that income fields contain only digits), and packages the data into a structured message such as a JSON object with keys for income, fixed expenditures, and household composition.

### Step 2:

Terminal sends the structured profile message to the server over a network using a secure communication protocol.

The input of this step is the structured profile parameters held in the terminal, and the output is a network request containing these parameters in the body of an HTTP message addressed to a server endpoint.

Terminal initiates an HTTPS POST request to a predefined URL, places the structured data into the request body, and attaches authentication or session tokens in the headers so that the server can identify the user.

### Step 3:

Server receives the network request from the terminal and parses the profile data. The input of this step is the HTTP request containing serialized profile data, and the output is an internal data structure, such as a dictionary or record object, that holds the parsed income, fixed expenditures, and household composition.

Server uses a web application framework to route the request to a handler, decodes the message body from JSON or form encoding, extracts each field, and performs semantic validation (for example, verifying that income is greater than zero and that household size is an integer).

### Step 4:

Server stores the validated profile data in a storage unit as record information.

The input of this step is the validated internal data structure representing the profile, and the output is a persistent database record associated with the user.

Server uses a database access layer to map the profile fields to columns in a user profile table and executes an insert or update operation, committing the transaction so that the values can be retrieved for later computation and generation.

### Step 5:

Server loads profile records for numerical computation using a data analysis library.

The input of this step is one or more database records representing the user's income, fixed expenditures, and household composition, and the output is an in-memory tabular structure, such as a data frame, with typed columns for each parameter.

Server issues a database query filtered by user identifier, receives the result set, and constructs a data frame where each column is converted to an appropriate numeric or categorical type, enabling efficient vectorized operations in subsequent processing.

### Step 6:

Server computes disposable income using a numerical computation library.

The input of this step is the data frame containing numeric columns for income and fixed expenditures, and the output is a computed disposable income value stored as a numeric scalar or array element.

Server converts the relevant columns to multidimensional array objects, subtracts the fixed expenditures array from the income array using a vectorized subtraction operation, and assigns the result to a new field representing disposable income, thereby minimizing overhead from iterative loops.

### Step 7:

Server calculates a food expense budget from the disposable income and household composition.

The input of this step is the disposable income value and the household composition attributes from the data frame, and the output is a scalar numeric value representing the food expense budget for a given period.

Server multiplies the disposable income by a preconfigured ratio to obtain a base food budget and then adjusts this value using coefficients derived from the number and types of household members, applying vectorized multiplication and addition operations to efficiently compute the adjusted food expense budget.

### Step 8:

Server constructs a prompt sentence for a generative AI model based on the computed budget and profile data.

The input of this step is the numeric food expense budget and the profile parameters (income, fixed expenditures, household composition, and optionally preferences), and the output is a natural language text string formatted as a prompt sentence.

Server uses a template containing placeholder fields for monetary amounts and household details, fills the placeholders with the corresponding numeric and textual values, and concatenates additional constraint phrases such as nutritional balance and time limits to form a complete prompt sentence suitable for conditioning the generative AI model.

### Step 9:

Server tokenizes the prompt sentence and feeds it into the generative AI model for inference.

The input of this step is the prompt sentence as a text string, and the output is a sequence of generated token identifiers representing menu descriptions and ingredient information.

Server uses a tokenizer associated with the generative AI model to convert the prompt sentence into a sequence of integer token IDs, constructs an input tensor from these IDs, and invokes the model's inference function, which performs multi-layer attention and feedforward operations to compute output token distributions and select the most likely sequence of tokens using a decoding strategy such as beam search.

### Step 10:

Server decodes the output tokens from the generative AI model into generated text. The input of this step is the sequence of output token identifiers produced by the model, and the output is a human-readable text block describing menus, ingredients, quantities, and costs. Server applies the inverse of the tokenizer mapping to convert token IDs back to words and punctuation, concatenates them into sentences, and normalizes formatting (for example, ensuring line breaks between days and items), resulting in a coherent text representing a planned set of home-cooking menus.

### Step 11:

Server parses the generated text into structured data elements.

The input of this step is the generated menu text, and the output is a collection of structured records containing fields such as menu name, temporal information, ingredient name, quantity, unit, and estimated cost.

Server applies parsing rules, such as regular expressions and delimiter-based splitting, to detect section headers (for example, “Day 1”), dish titles, and ingredient lines, then extracts numeric substrings as quantities, matches recognized units, and assigns the remainder as ingredient names, producing structured objects suitable for database insertion.

### Step 12:

Server stores the structured menu and ingredient data in the storage unit.

The input of this step is the set of structured records produced by the parser, and the output is normalized database entries in menu and ingredient tables linked to the user.

Server maps each structured record to table rows, assigns unique identifiers to menus, links ingredients to menus via foreign keys, and executes batch insert operations, thereby enabling fast indexed retrieval for future user interactions and aggregation.

### Step 13:

Server prepares display data for menu candidates and sends it to the terminal.

The input of this step is the stored structured data for menus and their summaries, and the output is a formatted response message containing a list of menu candidates with key attributes.

Server selects a subset of menu fields such as identifiers, names, daily cost estimates, and key ingredients, organizes them into a compact structured format, and transmits this data over the network to the terminal via a response message.

### Step 14:

Terminal receives the menu candidate data and renders it on a display. The input of this step is the response message containing menu candidate information, and the output is a graphical representation of selectable menu items on the terminal screen. Terminal parses the message, creates user interface elements such as list items or cards for each menu, and displays menu names, costs, and ingredient summaries, along with interactive controls such as buttons or checkboxes for selection.

### Step 15:

User examines the displayed menus on the terminal and selects one or more preferred menu candidates.

The input of this step is the visual representation of menu candidates on the screen, and the output is a user selection captured as user interface events associated with specific menu identifiers.

User taps or clicks selection controls next to desired menus and confirms the choice through an on-screen confirmation element, causing the terminal to record the selected identifiers in memory.

### Step 16:

Terminal sends the selected menu identifiers back to the server.

The input of this step is the set of selected menu identifiers stored in the terminal, and the output is a network request containing these identifiers addressed to a server endpoint for selection submission.

Terminal packages the identifiers into a structured payload, such as an array under a key for selected menus, and performs an HTTPS POST request so that the server can retrieve and process the user's selection.

### Step 17:

Server retrieves ingredient records associated with the selected menus and aggregates ingredient quantities.

The input of this step is the list of selected menu identifiers received from the terminal, and the output is an aggregated ingredient list in which quantities for identical ingredients are summed.

Server queries the ingredient table for records whose menu IDs match the selected identifiers, loads the results into a tabular in-memory structure, groups rows by ingredient name and unit, and applies a summation operation on the quantity column, producing a consolidated purchase candidate list that specifies total required amounts per ingredient.

### Step 18:

Server maps aggregated ingredients to products available from a delivery service and builds order information.

The input of this step is the consolidated purchase candidate list and product catalog and inventory data obtained from the delivery service, and the output is a finalized order information structure containing product identifiers, quantities, and delivery parameters.

Server searches a mapping table or index for each ingredient to find compatible products, filters candidates using inventory status and package sizes, chooses appropriate product identifiers according to user preferences and cost criteria, and constructs an order object including product IDs, quantities, delivery address, and requested delivery time window.

### Step 19:

Server transmits the order information to the delivery service and receives an order response.

The input of this step is the assembled order information, and the output is an order response containing an order acceptance result and delivery schedule information.

Server sends the order information via an authenticated API call using a standardized protocol to the delivery service information processing system, waits for the response, and parses the returned data fields such as acceptance status, order ID, estimated delivery time, and any product substitutions.

### Step 20:

Server stores the order response and notifies the terminal of the order status.

The input of this step is the order response data from the delivery service, and the output is a stored order record in the database and a notification message sent to the terminal.

Server writes the order ID, status, and schedule into an order table, associates it with the user, and constructs a concise status summary that is transmitted to the terminal over the network.

### Step 21:

Terminal displays the order confirmation and delivery schedule to the user. The input of this step is the status summary message from the server, and the output is a visual confirmation screen showing ordered items, total cost, and expected delivery time.

Terminal decodes the message, populates interface elements with order details, and presents options for the user to acknowledge, review, or potentially request changes, enabling transparent tracking of the automated ordering process.

### Step 22:

Server collects interaction data, preference signals, and emotional state indicators from user behavior and inputs on the terminal.

The input of this step is a stream of user interaction logs (such as menu selections, rejections, and navigation patterns) and textual or spoken inputs received from the terminal, and the output is updated preference profiles and emotional state estimates stored in the storage unit.

Server applies feature extraction to the logs (for example, counting repeated rejections of certain ingredients) and runs an emotion classification model on recent textual input to infer emotional categories, then writes this information into dedicated preference and emotion fields linked to the user's profile.

### Step 23:

Server uses updated preference and emotional state information to modify future prompt sentences and filter generated menus.

The input of this step is the user's preference profile and emotional state records, and the output is adjusted prompt sentences and ranked sets of menu candidates tailored to the user's current context.

Server injects new constraints or stylistic instructions into the prompt template (for example, “simplify recipes and reduce cooking time” when the user is tired) and, after generation, applies weighting or filtering rules to rank menus that better fit the detected preferences and mood, thereby generating outputs that better satisfy user needs while maintaining budget and nutritional constraints.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented budget and menu planning systems generally process user financial data, generate static budget values, or present pre-defined recipe lists. Such systems typically lack an integrated, automated mechanism that (i) converts raw economic and household data into a machine-usable food budget, (ii) dynamically generates context-aware menu data using a generative AI model via a precise prompt sentence, and (iii) reconciles the generated menu data with real-time or near real-time product information, including prices, discounts, and sales promotions. As a result, existing systems often require the user to manually search for affordable ingredients, cross-check menu plans against the user's budget, and iteratively adjust menus, which leads to increased processing latency on the user side, fragmented data flows, and suboptimal utilization of computational resources. Moreover, many existing systems treat the generative AI model as an isolated component that merely outputs text recipes, without systematically structuring the generated data into machine-readable ingredient information and without tightly coupling such information with external sales data sources. This separation causes redundancy in parsing and filtering operations, increases computational overhead, and limits the system's ability to perform accurate cost estimation and budget conformity checks at scale.

Further, conventional systems do not provide a unified server-side architecture that automatically generates a structured natural-language prompt sentence from normalized user profile and budget information, uses that prompt sentence to invoke a generative AI model, and then programmatically parses the model output to compute an expected total cost and annotate the menu with a budget compliance determination. This lack of integration prevents efficient server-side decision-making and forces user terminals to perform additional processing, which can degrade performance, increase communication overhead, and result in inconsistent user experiences across devices.

Accordingly, there is a need for an improved computer-implemented technique that centralizes and optimizes the processing of user economic and household data, prompt sentence generation, generative AI model invocation, structured menu parsing, product and sales information retrieval, and cost-benchmarking against a computed food budget. Such a technique should reduce manual intervention, minimize redundant computations, and enhance the technical efficiency and responsiveness of the overall system by coordinating these operations within a server-controlled processing pipeline.

The specific processing by the specific processing unit 290 of the data processing device 12 in Example 2 is realized by the following means.

The present invention provides a server comprising a processor and a storage device, wherein the processor is configured to receive, from a communication terminal, user economic information and household information, calculate a food budget by performing an arithmetic operation on the user economic information, generate a structured prompt sentence in a natural language based on the food budget and the household information, transmit a request including the prompt sentence to a generative AI model so as to cause the generative AI model to generate home-cooked menu information, parse the generated home-cooked menu information to extract ingredient information, retrieve, from an information storage apparatus or an external information providing apparatus, product and service information including price information, discount information, or sales promotion information corresponding to the ingredient information, estimate an expected total cost for the home-cooked menu information based on the retrieved product and service information and the food budget, determine whether the expected total cost falls within the food budget, append a determination result to the home-cooked menu information, and integrate and transmit presentation information including the home-cooked menu information, the product and service information, and the determination result to the communication terminal. This enables the server to perform an end-to-end, machine-optimized processing pipeline that transforms user economic data into budget-constrained, AI-generated menu information with associated cost and sales metadata, thereby improving computational efficiency, reducing client-side processing load, and enhancing responsiveness and consistency of the system across heterogeneous terminals.

The term “processor” refers to a hardware-implemented information processing element, such as a central processing unit or other computing circuitry, that executes program instructions to perform arithmetic operations, logical operations, data communication control, and data storage control in the system.

The term “storage device” refers to a hardware-implemented memory component, such as a semiconductor memory, magnetic storage, or optical storage, that stores program code, user information, budget information, menu information, and product or service information used by the processor.

The term “communication terminal” refers to an electronic apparatus, such as a mobile terminal, a tablet terminal, or a personal computer, that communicates with the server over a communication network to transmit user information and receive presentation information.

The term “user economic information” refers to information representing a user's financial status, including at least income information and expenditure information that are used to calculate a food budget.

The term “household information” refers to information representing the composition of a user's household, including at least a number of household members and optionally attributes of the household members.

The term “income” refers to a monetary amount received by a user over a predetermined period and used as a basis for calculating a food budget.

The term “expenditure” refers to a monetary amount spent or reserved by a user over a predetermined period, including fixed costs and other recurring payments, and used as a basis for calculating a food budget.

The term “food budget” refers to a calculated monetary amount that is available to be allocated to food-related expenses for a predetermined period, obtained by performing an arithmetic operation on the user economic information.

The term “prompt sentence” refers to a text string expressed in a natural language, generated by the processor, that encodes conditions or constraints based on at least the food budget and the household information, and that is provided as input to a generative AI model to control its output.

The term “generative AI model” refers to a machine learning model, such as a generative language model, that receives an input including a prompt sentence and generates output data, such as menu information, by performing learned probabilistic inference.

The term “home-cooked menu information” refers to information describing one or more meals prepared in a household environment, including dish names, ingredient information, and optionally preparation instructions, that is generated by the generative AI model based on the prompt sentence.

The term “ingredient information” refers to data representing food items or components required to prepare the home-cooked menu, including at least item names and optionally quantities, which are extracted from the home-cooked menu information. The term “information storage apparatus” refers to a data storage system, such as a database server, that stores product information, price information, discount information, or sales promotion information associated with ingredients.

The term “external information providing apparatus” refers to an external system, such as a remote server or service, that provides product or service information via a communication network in response to a request from the processor.

The term “product and service information” refers to information relating to goods or services associated with ingredients, including at least one of price information, discount information, and sales promotion information obtained from the information storage apparatus or the external information providing apparatus.

The term “household-burden-reduction product information and service information” refers to product and service information that indicates goods or services capable of reducing a financial burden on a household by offering favorable prices, discounts, or promotions for ingredients used in the home-cooked menu.

The term “price information” refers to data indicating a monetary amount at which a product or service is offered for sale.

The term “discount information” refers to data indicating a reduction or modification of a price, such as a percentage discount, a coupon, or a special offer condition, applied to a product or service.

The term “sales promotion information” refers to data indicating a promotional activity, such as a limited-time sale, a bundle offer, or a loyalty program, designed to incentivize purchase of a product or service.

The term “expected total cost” refers to a computed monetary value representing an estimated aggregate expense required to obtain ingredients for the home-cooked menu over an entire menu or over a predetermined period, based on the product and service information. The term “determination result” refers to information indicating a result of comparing the expected total cost with the food budget, including at least whether the expected total cost falls within the food budget.

The term “presentation information” refers to data generated by the processor by integrating the home-cooked menu information, the product and service information, and the determination result into a format suitable for display or use at the communication terminal.

The term “user preference information” refers to information indicating a user's likes or dislikes, dietary preferences, or culinary tendencies, which may be used to adjust content of the home-cooked menu information.

The term “user health condition information” refers to information representing a user's health status or dietary restrictions, such as low-salt or low-fat requirements, which may be used to adjust content of the home-cooked menu information.

The term “order information” refers to data representing an instruction set that specifies items, quantities, and destination details for ordering products corresponding to ingredient information through a delivery service.

The term “delivery service” refers to a service system that receives order information and arranges for transportation and delivery of products, such as food items, to a specified location.

In one embodiment, a server cooperates with a terminal and a user to implement the claimed system.

The server includes at least one processor, a main memory, a non-volatile storage device, and a communication interface. For example, the server uses a central processing unit conforming to a general-purpose instruction set architecture, such as an x86-compatible processor, executes an operating system such as a server-oriented operating system, and runs application software implemented in a programming language such as Python. The server stores application modules, trained parameter data of a generative AI model, and database management software such as a relational database management system. The server provides an application programming interface accessible from one or more terminals over a packet-based communication network.

The terminal includes a processor, a memory, a display device, user input devices such as a touchscreen or keyboard, and a communication function. The terminal executes an operating system such as a smartphone operating system or a desktop operating system and runs a client program, for example a web browser or a native application. The terminal provides a graphical user interface through which the user inputs economic information and household information and views presentation information returned by the server.

The user operates the terminal to provide user economic information and household information. The user economic information includes at least a monthly income amount and a monthly expenditure amount, such as a fixed cost for housing and utilities. The household information includes at least a number of household members, and may further include classification of members into adults and children. The terminal converts the input into a structured data format and transmits the data to the server via the communication interface. The use of structured transmission from the terminal to the server enables normalized storage and efficient processing of the data at the server side.

The server stores the received user economic information and household information in a storage device managed by the database management software. The server uses a normalized table structure, for example a user profile table having fields for a user identifier, income, expenditure, number of household members, and computed food budget. The server thereby maintains consistent records for multiple users, which improves data management and avoids redundancy.

The server performs an arithmetic operation on the income and the expenditure included in the user economic information to calculate a food budget. The server subtracts at least the expenditure value from the income value to obtain a remaining amount available for food. In some embodiments, the server applies weighting factors based on the number of household members or adds rule-based adjustments for savings or irregular expenses. The server records the food budget as budget information in the user profile table. By performing this computation centrally at the server, the system reduces inconsistent local calculations at terminals and improves accuracy and reproducibility.

The server generates a prompt sentence for a generative AI model based on the food budget and the household information. The server uses a dedicated prompt generation module that applies a deterministic template and rule set to insert numeric values and household attributes into a natural-language pattern. For example, the server can generate a prompt sentence such as:

“Monthly income is 300,000 yen, fixed expenses are 200,000 yen, and the family consists of 4 people. Based on a food budget of 100,000 yen, please propose healthy home-cooked dinner menus for 7 days. Please include dish names, ingredient lists, simple cooking steps, and try to keep the total estimated ingredient cost within the food budget.” In another example, the server generates a prompt sentence such as:

“Monthly income is 250,000 yen, fixed expenses are 180,000 yen, and the family consists of 3 people (2 adults, 1 child). Based on the remaining food budget, please propose a 5-day plan of low-salt and low-fat home-cooked menus. Include approximate ingredient quantities per person and rough cost estimates for each day.”

In yet another example, the server generates a prompt sentence such as: “The monthly income is 400,000 yen, fixed expenses are 260,000 yen, and the family consists of 5 members (2 adults, 3 children). Based on a food budget of 140,000 yen, please generate weekly breakfast, lunch, and dinner menus that are economical yet nutritious. Use ingredients that are commonly available in supermarkets, and prioritize recipes that can be cooked in under 30 minutes.”

The server generates these prompt sentences by constructing a sequence of tokens representing numeric values, text segments, and constraint descriptors, which are then serialized into a natural-language sentence. This structured prompt generation reduces ambiguity and leads to more stable outputs from the generative AI model, thereby improving the technical reliability of the system.

The server uses a generative AI model implemented as a neural network-based language model. In one embodiment, the generative AI model is a transformer-based architecture having an input embedding layer, multiple self-attention layers, feed-forward layers, and an output projection layer. The model is trained in advance on textual corpora including recipes and nutritional information. During training, the server or another training system minimizes a loss function such as a cross-entropy loss between predicted tokens and ground-truth tokens, and updates model weights using an optimization algorithm such as stochastic gradient descent with adaptive learning rate. The training process may include techniques such as mini-batch training, dropout regularization, and weight decay. The system may also apply fine-tuning on domain-specific diet and budget data to improve accuracy for food-related outputs.

The server supplies the prompt sentence to the generative AI model, which is stored locally or accessed via an external inference service. The server converts the natural-language prompt sentence into token identifiers using a tokenizer. The model processes the token sequence through the self-attention layers, which compute attention weights for each position based on queries, keys, and values derived from the token embeddings. By using this architecture, the model can capture long-range dependencies between budget constraints and menu structure. The server receives a sequence of output token probabilities from the final layer and decodes them into text representing home-cooked menu information. The server may control decoding using a deterministic or constrained decoding algorithm, such as beam search with a penalty for over-budget ingredients, to reduce variations in output and maintain consistency.

The server parses the generated menu text into structured home-cooked menu information. The server uses a parsing module that identifies days, meal types, dish names, and ingredient lists. The server applies pattern-based extraction rules and, in some embodiments, a secondary trained classifier to recognize ingredient tokens. The server creates internal records for each dish, including fields for dish name, list of ingredient names, and optional preparation steps. This structured representation enables downstream cost estimation and matching with product data. The explicit data structure, such as a relational schema or a key-value representation, improves computational efficiency because repeated scanning of unstructured text is no longer required for each subsequent operation.

The server extracts ingredient information from the structured home-cooked menu information. The server normalizes the ingredient names by mapping synonyms and variants to standard forms using a lookup table or an embedding-based similarity measure. For example, the server maps “chicken thigh” and “chicken leg” to a standardized ingredient category “chicken.” By performing this normalization with a specific algorithm and data structure, the system reduces duplication in queries to product databases and thereby reduces database load and network traffic.

The server searches an information storage apparatus or an external information providing apparatus that stores product and service information corresponding to the ingredient information. The server queries one or more databases storing price information, discount information, and sales promotion information for food products. The server may use structured query language to retrieve records where the normalized ingredient name matches an item category and where the time period or region matches the user context. In some embodiments, the server aggregates product data from multiple sources and ranks entries based on a scoring function that accounts for unit price, discount rate, and distance or delivery conditions. This ranking algorithm improves the quality of recommendations and reduces the number of items that must be processed further.

The server uses the retrieved product and service information and the stored food budget to calculate an expected total cost for the home-cooked menu information. The server determines approximate quantities for each ingredient based on the number of household members and per-person consumption rules. The server multiplies the normalized quantity by a unit price derived from the product and service information. If multiple candidate products exist for a single ingredient, the server applies a rule that selects a product with the lowest effective cost given discount information and promotion conditions. The server sums the costs over all ingredients and over a predetermined period, such as one week, to derive the expected total cost.

The server compares the expected total cost with the food budget stored in the user profile table and produces a determination result indicating whether the expected total cost falls within the food budget. The determination result may indicate, for example, “within budget,” “over budget,” or “under budget by a specified amount.” The server appends this determination result to the home-cooked menu information as additional metadata. This operation is performed entirely by the server processor using numerical comparisons and avoids manual evaluation by the user, thereby reducing user cognitive load and improving processing speed.

The server integrates the home-cooked menu information, the retrieved product and service information, and the determination result into presentation information. The server uses a predetermined data schema for the presentation information, including sections for budget summary, daily menus, itemized ingredient lists, and associated offers or promotions. The server then transmits the presentation information to the terminal via the communication interface.

The terminal receives the presentation information and renders it on the display. The terminal presents, for example, a weekly schedule of recommended dinners, each listing dish names and ingredients, alongside budget indicators and notes such as “Chicken thigh is on sale at a nearby store” or “Tofu is available with a multi-buy discount.” The terminal may allow the user to drill down into a specific dish to see more detailed instructions. This arrangement offloads heavy computations to the server and allows the terminal to remain lightweight.

In another embodiment, the server includes user preference information and user health condition information in the prompt sentence. The server stores, for each user, preference data such as preferred cuisine styles, disliked ingredients, and maximum tolerated cooking time, as well as health-related flags such as low-salt requirements or low-fat requirements. The server modifies the template for the prompt sentence to insert these constraints, for example:

“Monthly income is 300,000 yen, fixed expenses are 200,000 yen, and the family consists of 4 people. One adult must follow a low-salt diet. Based on a food budget of 100,000 yen, please propose healthy home-cooked dinner menus for 7 days that are low in salt. Please include dish names, ingredient lists, simple cooking steps, and try to keep the total estimated ingredient cost within the food budget.”

By encoding such constraints directly into the prompt, the system causes the generative AI model to produce menus tailored to specific health and preference conditions. The server thus achieves a combination of budget constraints and health constraints that would be difficult to manage manually and that would impose high complexity if implemented with static rule-based systems.

In another embodiment, the server generates order information based on the home-cooked menu information and the associated product and service information. The server groups ingredients by supplier and constructs a structured record representing a set of items, quantities, and delivery options. The server then transmits the order information to the terminal, which allows the user to confirm or modify the selection and forward it to a delivery service. This configuration reduces the number of separate transactions and minimizes errors in manual entry of item information.

The described architecture and data flow provide technical improvements over conventional systems. Because the server generates a well-structured prompt sentence and uses a generative AI model with a defined neural network architecture, the system reduces trial-and-error by the user and stabilizes the quality of generated menus. By normalizing ingredient information and using optimized database queries, the system reduces redundant lookups and lowers the computational load on the storage apparatus and the network. By centralizing budget calculation, cost estimation, and constraint checking at the server, the system reduces duplicated processing across terminals and ensures consistent results, which improves overall processing speed and reduces communication overhead resulting from repeated back-and-forth adjustments.

The server uses the generative AI model in combination with deterministic rule-based modules, such as prompt generation, ingredient normalization, and cost estimation, so that the system behavior is more predictable and tuned for efficient computation compared to pure manual or ad hoc usage of a language model. The model is not merely automating human mental activity; rather, the model is integrated into a computational pipeline that uses specific data structures, predetermined templates, and cost functions to achieve lower latency and improved accuracy in generating budget-constrained menus. The use of precomputed embeddings, attention structures, and loss-based training produces a model that can evaluate complex relationships between budget constraints, nutritional balance, and ingredient selection in a high-dimensional space, thereby achieving results that would be impractical to compute using simple rule-based algorithms alone.

In alternative embodiments, the server may deploy the generative AI model on different types of accelerators, such as graphics processing units, and adjust batch sizes and sequence lengths to maximize throughput under available hardware constraints. The server may also maintain a cache of recent prompt sentences and corresponding outputs to serve similar requests with reduced inference time, which further improves processing efficiency and reduces system latency. The server may optionally maintain separate models or parameter sets for different regions or dietary cultures, storing them in the storage device and selecting appropriate variants based on geographic or cultural data included in the user profile.

Through these configurations, the server, terminal, and user cooperate to implement the claimed system in a way that improves computer operation itself, including the efficiency of data storage, retrieval, and processing, the stability and quality of generative AI outputs, and the reduction of unnecessary network traffic and client-side computation.

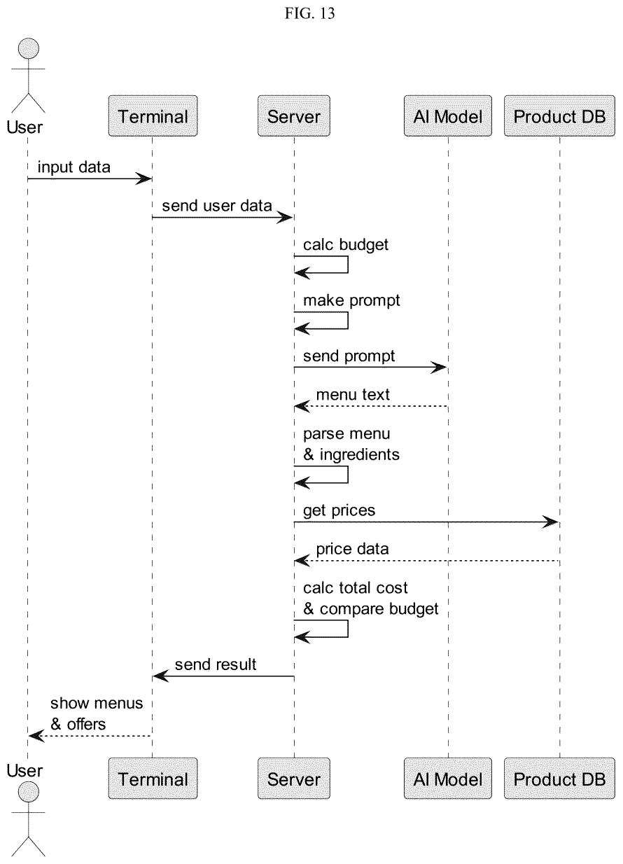

The following describes the processing flow using FIG. 13.

### Step 1:

User operates the terminal to input user economic information and household information.

User views an input screen on the terminal and enters values such as monthly income, monthly fixed expenditure, and number of household members using a touchscreen or keyboard.

Terminal receives these raw input values as characters, validates that required fields are present and that numerical fields contain valid numbers, and converts the values into an internal structured record.

Input: raw text entries for income, expenditure, and household size.

Processing: terminal parses the text into numeric data types and checks ranges and formats.

Output: a structured data object containing normalized income, expenditure, and household member count, ready to be transmitted to the server.

### Step 2:

Terminal transmits the structured user economic information and household information to the server.

Terminal establishes a network connection using a communication protocol and encapsulates the structured data object into a request message.

Input: the structured data object containing income, expenditure, and household member count.

Processing: terminal serializes the object into a message format, attaches user identification metadata if available, and sends the message via a request to a predefined server address.

Output: a network request containing user economic and household information delivered to the server.

### Step 3:

Server receives and stores the user economic information and household information.

Server listens on an application endpoint, accepts the request from the terminal, and extracts the message body.

Input: serialized user economic and household information from the terminal.

Processing: server deserializes the message into internal variables, validates the numerical ranges and logical consistency (for example, income greater than zero, household member count at least one), and writes the values into database fields within a user profile table.

Output: persistent records in the storage device containing normalized income, expenditure, and household member count associated with a user identifier.

### Step 4:

Server calculates a food budget based on the stored user economic information.

Server reads the income and expenditure values from the user profile record in the database.

Input: income value, expenditure value, and optionally previously stored rules or parameters for budget calculation.

Processing: server performs an arithmetic subtraction operation to compute a remaining amount (income minus expenditure) and optionally applies multipliers or thresholds according to configuration data, then rounds the result to a suitable unit.

Output: a computed food budget value stored as budget information in the user profile record.

### Step 5:

Server constructs a prompt sentence for the generative AI model using the food budget and household information.

Server retrieves the food budget and the number of household members from the database for the target user.

Input: numeric food budget, household member count, and optional preference or health condition indicators.

Processing: server inserts these values into a pre-defined natural-language template, concatenating fixed strings with numeric conversions and descriptors to form a coherent prompt sentence.

For example, the server generates a prompt sentence such as:

“Monthly income is 300,000 yen, fixed expenses are 200,000 yen, and the family consists of 4 people. Based on a food budget of 100,000 yen, please propose healthy home-cooked dinner menus for 7 days. Please include dish names, ingredient lists, simple cooking steps, and try to keep the total estimated ingredient cost within the food budget.”

Output: a fully formed natural-language prompt sentence ready to be supplied to the generative AI model.

### Step 6:

Server sends the prompt sentence to the generative AI model and obtains menu text as a response.

Server provides the prompt sentence as input to the generative AI model through a model inference interface.

Input: the prompt sentence generated in natural language.

Processing: server tokenizes the prompt sentence into token identifiers, feeds the token sequence into a transformer-based neural network implementing the generative AI model, and runs the model to compute successive token probability distributions using attention layers and feed-forward layers. The model samples or selects output tokens according to a decoding strategy until an end condition is reached, and server decodes the tokens back into text.

Output: generated menu text describing home-cooked menus, including dish names, ingredients, and optional preparation steps, returned to the server.

### Step 7:

Server parses the generated menu text into structured home-cooked menu information.

Server processes the menu text line by line and segment by segment to identify day labels, meal types, dish names, and ingredient lists.

Input: unstructured menu text from the generative AI model.

Processing: server applies pattern recognition rules, such as detecting lines beginning with “Day 1” or “Dinner,” splits ingredient lists at delimiters such as commas, and uses lookup tables or classifiers to distinguish ingredients from other textual content. Server then creates structured records for each day and each dish, including an array of ingredients for each dish.

Output: a structured menu data set, comprising records that map each day and meal type to dish names and associated ingredient information.

### Step 8:

Server extracts and normalizes ingredient information from the structured home-cooked menu information.

Server inspects each dish record, collects ingredient names, and standardizes their representation.

Input: structured menu data containing ingredient names in free text form.

Processing: server applies normalization rules and dictionary mappings to unify different expressions of the same ingredient, such as mapping “chicken thigh” and “chicken leg” to a standard ingredient category “chicken,” and removes duplicates to form a unique ingredient list.

Output: a normalized list of ingredient identifiers and associated attributes, stored in a form suitable for querying product and sales databases.

### Step 9:

Server retrieves product and service information corresponding to the normalized ingredient list.

Server connects to one or more information storage apparatuses or external information providing apparatuses that hold price and promotion data.

Input: normalized ingredient identifiers and user context information such as region or preferred store type.

Processing: server constructs and issues database queries or service requests that match ingredient identifiers to product entries, filters results by region and time period, and gathers relevant fields including unit price, discount rate, promotion description, and availability.

Output: a product and service information set for each ingredient, including price information, discount information, and sales promotion information.

### Step 10:

Server estimates an expected total cost for the home-cooked menu based on the product and service information and the food budget.

Server uses the structured menu data along with the product information to determine quantities and cost.

Input: structured menu information with ingredients, normalized ingredient list, product and service information, and the food budget.

Processing: server determines quantity requirements for each ingredient from per-person consumption rules multiplied by the number of household members, selects appropriate product entries for each ingredient based on effective unit cost including discounts, multiplies quantities by unit prices to obtain cost per ingredient, and sums all ingredient costs across the entire menu period.

Output: a numerical expected total cost value for the menu and an itemized cost breakdown per ingredient or per day.

### Step 11:

Server compares the expected total cost with the food budget and generates a determination result.

Server accesses the stored food budget for the user and compares it against the computed expected total cost.

Input: expected total cost and food budget value.

Processing: server performs a numerical comparison, calculates a difference amount if needed, and classifies the result into categories such as “within budget,” “over budget,” or “under budget by a specified amount.” Server then attaches this determination as a field to the menu data structure.

Output: an annotated menu data structure containing a determination result indicating budget compliance status and any overage or surplus values.

### Step 12:

Server integrates the menu, cost, and product information into presentation information and transmits it to the terminal.

Server assembles a complete response package that includes the structured home-cooked menu information, the associated product and service information, and the budget determination result.

Input: annotated menu data structure, product and service information, and determination result.

Processing: server formats the data into a hierarchical representation that groups dishes by day and links each ingredient to corresponding store offers and cost data, and compresses or encodes the representation as needed for network transmission.

Output: presentation information containing menu plans, ingredient offers, and budget status, sent as a response message from the server to the terminal.

### Step 13:

Terminal receives the presentation information and renders it to the user.

Terminal decodes the received response and maps the structured content to user interface components.

Input: presentation information transmitted by the server.

Processing: terminal parses the hierarchical data, generates visual elements such as daily menu lists, price tags, and budget status indicators, and arranges them on the display according to a predefined layout. Terminal may create interactive elements that the user can select to view more detailed information, but the terminal does not alter the underlying calculation results.

Output: a visual display on the terminal screen showing the recommended home-cooked menus, corresponding low-cost product options, and clear indications of whether the menus fit within the user's food budget.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented budgeting and recommendation systems typically treat budget calculation, content generation, recommendation, and ordering as loosely coupled and sequential functions. A processor calculates a static food budget from simple income and expense fields, and then a separate content engine proposes recipes or products without deeply integrating nutritional constraints, emotional context, and real-time commerce data. As a result, several technical problems arise in the operation of the information processing apparatus.

First, when a processor generates menu or product information within a budget, the processor generally does not perform iterative machine-level coordination between a generated natural language menu and structured nutritional data. Generated text is merely presented to a user, and any nutritional correction is performed manually by the user. This leads to unnecessary processor cycles and network calls because the system may repeatedly regenerate menus or require additional user input due to undetected nutritional imbalances. There is no mechanism in the processor for automatically evaluating generated menu information against structured nutrient component information and automatically refining the prompt sentence supplied to a generative AI model. Consequently, the computing resources of the information processing apparatus are not used efficiently.

Second, emotional state information of the user, if used at all, is typically handled in a separate user interface layer and is not persistently fed back into the core generation logic executed by the processor. Known systems do not treat emotion estimation outputs as first-class machine-readable parameters that dynamically condition the construction of prompt sentences for a generative AI model. Emotional state is rarely stored as history information and is not used to adapt the generative behavior of the model over time. Thus, the processing unit cannot automatically optimize the generation of menu and recommendation information in response to changing emotional patterns, leading to repetitive or non-responsive content and inefficient use of the generative model.

Third, many systems generate recipes or recommendations independently from downstream commerce and logistics processing. Menu generation does not produce integrated purchase candidate information normalized to sales units, nor does it automatically incorporate discount information or special sale information from external distribution systems. As a result, the processor must perform multiple disjoint queries and conversions whenever the user wishes to place an order, increasing memory access, data transformation, and network communication overhead. This separation also leads to redundant computations when menus are edited: each change may require a full recomputation of shopping lists and discount application.

Fourth, existing architectures do not provide a unified processing framework in which a processor acquires heterogeneous information (economic information, behavior history information, emotional state information, nutrient component information, discount information) and coordinates them through a structured cycle of prompt sentence generation, model invocation, evaluation, and refinement. Instead, they rely on ad-hoc scripts and tightly coupled application logic that are difficult to scale and optimize. This leads to increased latency in generating useful outputs, higher storage redundancy, and difficulties in maintaining model prompts and domain rules in a consistent manner.

Accordingly, there is a need for an improved information processing system and server configuration in which a processor is specifically configured to (i) calculate food budget information from economic information, (ii) generate structured prompt sentences for a generative AI model, (iii) automatically evaluate and modify generated menu information using structured nutrient component information, (iv) dynamically condition prompt sentences and outputs based on emotional state information and user history, and (v) generate integrated purchase candidate information including discount information and orderable item information. By architecting these interactions at the processor level, the system can technically improve the efficiency, responsiveness, and reliability of menu generation, recommendation, and ordering operations performed by the computer system.

The specific processing by the specific processing unit 290 of the data processing device 12 in Application Example 2 is realized by the following means.

The present invention provides a server comprising a processor and a memory storing instructions that, when executed by the processor, cause the processor to acquire economic information of a user and calculate food budget information allowable for the user on the basis of income information, fixed cost information, and household composition information of the user, to generate prompt sentence information expressed in a natural language on the basis of the food budget information and the household composition information and input the prompt sentence information to a generative AI model such that the generative AI model generates cooking menu information that is nutritionally balanced within a range of the food budget information together with ingredient information corresponding to the cooking menu information, to acquire nutrient component information corresponding to the ingredient information from an external information source or stored information, evaluate nutritional balance of the cooking menu information on the basis of the nutrient component information, and automatically modify the prompt sentence information or the cooking menu information in accordance with an evaluation result, to acquire behavior history information of the user and select merchandise information or service information related to the cooking menu information on the basis of purchase history information and preference information included in the behavior history information, to acquire emotional state information of the user and, in accordance with the emotional state information, add emotional-state-dependent ingredient conditions or cooking conditions to the prompt sentence information and re-input the prompt sentence information to the generative AI model such that the generative AI model generates, in accordance with the emotional state, the cooking menu information and the merchandise information or the service information, to create integrated purchase candidate information for a plurality of periods on the basis of the cooking menu information and the ingredient information, add discount information and special sale information to the purchase candidate information, and place the ingredient information in an orderable state via communication with a distribution information processing apparatus, and to output, via a user interface, the cooking menu information, the merchandise information, the service information, the discount information, and delivery information and partially update the prompt sentence information and the cooking menu information in accordance with editing operation information from the user. This enables the server to implement an integrated and iterative processing loop in which the processor coordinates budget calculation, prompt construction, generative AI inference, nutritional evaluation, emotion-conditioned refinement, and order preparation at the machine level, thereby reducing redundant computations and network calls, shortening response time for generating nutritionally and emotionally appropriate menus, and improving overall efficiency and technical performance of the computer system in generating, adapting, and operationalizing menu and recommendation information.

The term “economic information” refers to information indicating a financial situation of a user, including at least income information, fixed cost information, and household composition information of the user.

The term “income information” refers to information indicating monetary inflows of a user over a predetermined period, including salary, business revenue, and other periodic or non-periodic earnings.

The term “fixed cost information” refers to information indicating recurring monetary outflows of a user over a predetermined period, including housing expenses, utilities, communication fees, insurance fees, and other periodic payments.

The term “household composition information” refers to information indicating a structure of a user's household, including at least a number of household members, age categories, and relational roles such as adults and children.

The term “food budget information” refers to information indicating an allowable monetary amount that can be allocated to food-related expenditures for a user or a household during a predetermined period, calculated on the basis of economic information.

The term “prompt sentence information” refers to information representing a natural language instruction or query provided as input to a generative AI model, the instruction or query specifying conditions under which the generative AI model generates an output.

The term “generative AI model” refers to a trained information processing model that receives prompt sentence information as input and generates content information such as text data representing menus, lists of items, or recommendations, in accordance with learned parameters.

The term “cooking menu information” refers to information representing one or more meal plans, including dish names, meal structures, and optionally preparation instructions, for cooking by a user or a household.

The term “ingredient information” refers to information representing food items or materials required to realize cooking menu information, including types of ingredients, quantities, units, and optional attributes such as category or freshness.

The term “nutrient component information” refers to information representing nutritional characteristics of ingredients or food items, including at least energy value and macronutrient and micronutrient values per unit quantity.

The term “external information source” refers to an information storage or information providing apparatus located outside a server, which can be accessed via a communication network to obtain data such as nutrient component information or discount information.

The term “stored information” refers to information retained in a storage apparatus associated with the server, including databases, files, or caches that store previously acquired or preloaded data.

The term “behavior history information” refers to information representing past actions of a user in relation to goods or services, including at least purchase history information and preference information accumulated over time.

The term “purchase history information” refers to information representing records of goods or services acquired by a user, including item identifiers, quantities, prices, purchase times, and purchase channels.

The term “preference information” refers to information representing tendencies or likes and dislikes of a user inferred from explicit indications or behavior history information, including favored item categories, disfavored ingredients, and usage patterns.

The term “merchandise information” refers to information representing goods that can be provided to a user, including identifiers, descriptions, prices, and availability information.

The term “service information” refers to information representing services that can be provided to a user, including types of services, conditions of use, prices, and availability information.

The term “emotional state information” refers to information indicating a psychological state of a user, including classifications such as stress, joy, sadness, anger, or neutrality, and optionally confidence values.

The term “emotional-state-dependent ingredient conditions” refers to conditions regarding ingredient selection or exclusion that are determined in accordance with emotional state information, including requirements to include stress-relieving food items or to avoid certain types of food.

The term “emotional-state-dependent cooking conditions” refers to conditions regarding configuration of cooking menus that are determined in accordance with emotional state information, including requirements for simplicity of preparation, comfort-oriented dishes, or celebratory dishes.

The term “emotion estimation model” refers to an information processing model configured to receive image information and audio information and output emotional state information by performing classification or regression processing.

The term “image information” refers to information representing visual data captured by an imaging device, including still images or moving images containing at least a face or body of a user.

The term “audio information” refers to information representing sound data captured by a sound acquisition device, including at least voice signals of a user.

The term “history information” refers to information representing a time-series record of states or events associated with a user, including past emotional state information and behavior history information.

The term “integrated purchase candidate information” refers to information representing a consolidated set of items to be purchased over a plurality of periods, generated on the basis of cooking menu information and ingredient information, and organized for subsequent ordering.

The term “discount information” refers to information indicating a price reduction applicable to at least one good or service, including discount rates, discount amounts, and validity periods.

The term “special sale information” refers to information indicating a temporary sales condition for at least one good or service, under which the good or service is offered at a price lower than a usual price or under preferential conditions.

The term “distribution information processing apparatus” refers to an information processing apparatus operated by a distribution or logistics entity, configured to receive order information, manage inventory and delivery schedules, and output delivery information.

The term “delivery information” refers to information representing a delivery plan or delivery status of goods, including delivery destination, scheduled delivery time, and delivery tracking identifiers.

The term “user interface” refers to a hardware and software configuration that enables presentation of information to a user and reception of input operations from the user, including display devices, input devices, and associated control logic.

The term “editing operation information” refers to information representing user operations that modify or adjust generated information, including selection, deletion, replacement, or confirmation of menus, ingredients, or products.

The term “required quantity information” refers to information indicating quantities of respective ingredients necessary to realize cooking menu information over a predetermined period, before normalization to sales units.

The term “purchase list information” refers to information representing a list of items to be acquired, including items and normalized quantities aligned with predetermined sales units, used for ordering from an external distribution service.

The term “external distribution service information processing apparatus” refers to a distribution information processing apparatus managed by a commercial or logistics service that provides goods delivery to a user on the basis of received purchase list information.

In one embodiment, a server cooperates with at least one terminal operated by a user to implement the claimed system. The server includes at least one processor, a main memory, a non-volatile storage device, and a network interface. The terminal includes a display device, an input device, an imaging device, a sound acquisition device, and a communication module. The server executes a program stored in the storage device to perform the functions described below.

The server uses a general-purpose processor, such as a multi-core central processing unit, and optionally a graphics processing unit for accelerating machine learning inference. The server executes an operating system, such as a general-purpose server operating system, and runs middleware including a web server and an application framework. In one example, the server runs an application implemented using an application framework for handling Hypertext Transfer Protocol requests. The terminal executes an operating system for a mobile device or a personal computer and runs an application or browser that provides a graphical user interface to the user.

The server stores user-related data in a database management system, such as a relational database. The database stores tables representing economic information, behavior history information, emotional state information, nutrient component information, menu information, and purchase candidate information. Each table is structured with explicit fields. For example, the economic information table includes fields for user identifier, monthly income value, monthly fixed cost value, and number of household members. The behavior history information table includes fields for transaction identifier, item identifier, price, purchase timestamp, and category label. The emotional state information table includes fields for timestamp, emotional state label, and confidence score. The nutrient component information table includes fields for ingredient identifier, energy value, macronutrient values, micronutrient values, and unit type.

The server executes a budget calculation module implemented using a numerical computation library. This module loads income information, fixed cost information, and household composition information from the database. The server represents these values in multi-dimensional numerical arrays. The server performs arithmetic operations on the arrays, subtracting fixed costs from income to obtain disposable income and applying weighting coefficients based on household composition to determine food budget information. The server can store both a monthly food budget value and a derived daily food budget value in association with the user. By representing economic information as structured numerical arrays and performing vectorized arithmetic operations, the processor reduces instruction overhead and cache misses compared to naive scalar operations, thereby improving calculation speed and scalability when handling many users.

The server generates prompt sentence information as a structured text string. The server maintains prompt templates as parameterized strings in the storage device. Each template includes placeholders for numerical budget values, numbers of persons, duration, and emotional-state-dependent conditions. The server fills the placeholders using formatted string operations based on data retrieved from the database. For example, the server can generate the following prompt sentence:

“User's monthly income is 300,000 yen, fixed costs are 200,000 yen, and the family consists of 2 adults and 2 children. The daily food budget is approximately 1,300 yen for 4 people. Within this daily budget, propose a nutritionally balanced one-week self-cooking menu that includes at least one stress-relieving item per day, such as chamomile tea, leafy green vegetables, or foods rich in omega-3. Use ingredients that are easy to buy at ordinary supermarkets, and keep all recipes simple and quick to prepare.”

The server uses a generative AI model as the core engine to generate cooking menu information and related information from the prompt sentence information. In one embodiment, the generative AI model is implemented as a neural network language model. The neural network has a transformer architecture comprising an embedding layer, multiple self-attention layers, feed-forward layers, and an output projection layer. The model parameters include weight matrices and bias vectors for each layer. The model is trained in advance on a corpus of recipe texts, nutritional descriptions, and structured menu data to predict a sequence of tokens representing dish names and ingredient lists given a prompt. The server represents the prompt sentence information as a sequence of token identifiers using a tokenizer stored in memory. The server maps each token identifier to a dense vector representation using the embedding layer. The neural network applies self-attention operations, computing attention weights based on query, key, and value vectors and combining them to update hidden representations. The model finally outputs a probability distribution over token identifiers for each position in the text. The server performs sampling or greedy decoding based on these probabilities to generate output text tokens. By using a transformer-based generative AI model, the server can integrate diverse constraints embedded in the prompt sentence information, such as budget constraints, nutritional requirements, and emotional-state-dependent conditions, into a single generation process without manually coding all possible combinations as rules.

The server receives the output text from the generative AI model and transforms it into cooking menu information and ingredient information. The server parses the output using pattern matching and syntactic heuristics. The server defines a menu schema in the database with tables for days, meals, dishes, and ingredients. When the server encounters markers such as “Day 1”, “Breakfast”, or enumerated lists, the server maps them to specific records and relationships in the schema. The server detects ingredient lines by their structure (e.g., “ingredient name-quantity unit”) and extracts ingredient names, quantities, and units. This structured representation allows subsequent numeric processing on quantities and nutrient values.

The server obtains nutrient component information for each ingredient by querying an internal or external nutrient database. The server stores ingredient names and identifiers in the database and maintains a mapping table from human-readable ingredient names to nutrient entries. When the server processes a new ingredient name, the server performs text normalization and approximate string matching against known ingredient names to reduce mismatches. The server then retrieves corresponding nutrient component information, including energy and macro- and micro-nutrients, as numeric vectors. By structuring nutrient component information as numeric vectors and associating them with normalized ingredient identifiers, the server can efficiently aggregate nutritional values across multiple meals and periods using matrix multiplication and vector addition.

The server evaluates nutritional balance of the generated cooking menu information by aggregating nutrient component information per meal and per day. The server defines reference ranges for nutrient intake stored as threshold vectors in the database. The server performs element-wise comparisons between aggregated nutrient vectors and reference vectors. If an aggregated vector exceeds or falls short of specified thresholds, the server marks the corresponding menu entry with a flag. The evaluation result includes numeric indicators such as a deviation score for each nutrient dimension. The server then automatically modifies the prompt sentence information or the cooking menu information based on these indicators.

In one modification process, the server updates the prompt sentence information by appending constraints, such as “reduce sodium and processed meat” or “increase total vegetable intake to at least 350 grams per adult per day.” The server regenerates a new menu by re-inputting the modified prompt sentence information to the generative AI model. Example prompt sentences for this process include:

“Please adjust the following weekly menu so that sodium intake is moderate and each day includes at least 350 grams of vegetables per adult. Keep the total daily food cost within 1,300 yen for a family of four. Here is the current menu: [insert menu summary]. Return a revised seven-day menu with dish names and ingredients.”

By embedding numeric evaluation results into prompt modifications, the server executes a closed-loop optimization between symbolic generation and numeric evaluation. This loop improves accuracy of nutritional compliance without requiring a human operator to manually inspect all nutrients. Because the server performs evaluation and prompt adjustment using vectorized numeric operations and string manipulation on the server side, the system reduces repeated manual interventions and reduces the amount of data transmitted to the terminal.

The terminal captures emotional state information using the imaging device and sound acquisition device. The terminal records a short video sequence of the user and corresponding audio. The terminal preprocesses image information by detecting a face region and cropping it to a fixed resolution using an image processing library. The terminal preprocesses audio information by segmenting and normalizing the signal. The terminal transmits the preprocessed data to the server.

The server executes an emotion estimation model implemented as a neural network. In one embodiment, the emotion estimation model comprises a convolutional neural network for processing images and a recurrent neural network for processing audio. The convolutional network applies convolution and pooling layers to the cropped face image to extract feature maps representing local patterns around eyes, mouth, and other regions. The recurrent network uses a sequence of acoustic feature vectors extracted from the audio signal as input, such as Mel-frequency cepstral coefficients, pitch, and energy. The recurrent network outputs a hidden state vector representing temporal emotional patterns. The server concatenates the image-based feature vector and audio-based feature vector and feeds the concatenated vector into a fully connected classification layer that outputs a probability distribution over emotional state classes. The server uses a softmax function to produce normalized probabilities. The server selects the emotional state label with the highest probability and stores both the label and the probability as emotional state information in the database. The server trains the emotion estimation model in advance using supervised learning. The training dataset contains pairs of image frames and audio segments labeled with emotional categories. The server defines a loss function as a cross-entropy between predicted emotional probabilities and ground truth labels. The server updates the model weights using a gradient descent-based optimization algorithm. To improve generalization, the server applies data augmentation operations such as random cropping, horizontal flipping, and color jittering to images and random time-shifting and noise addition to audio. By using a multi-modal neural network and training it with explicit loss functions and augmentation, the server achieves higher robustness and accuracy in emotion estimation than rule-based methods. Because the server stores emotional state information as history information, the server can adapt future prompt sentence information based on long-term patterns, improving relevance of generated menus and recommendations.

The server uses emotional state information to generate emotional-state-dependent ingredient conditions and cooking conditions. For example, when the emotional state information indicates stress, the server adds conditions requiring inclusion of stress-relieving ingredients such as herbal teas, foods rich in magnesium, or foods associated with comfort. When the emotional state information indicates sadness, the server adds conditions to include uplifting dishes or preferred sweet items. The server maintains a rule table mapping emotional states to ingredient categories and dish styles. The server consults this rule table and selects concrete ingredient constraints. The server then integrates these constraints into the prompt sentence information. Example prompt sentences include:

“The user is currently feeling stressed. Within a budget of 5,000 yen, propose a two-day menu that includes stress-relieving ingredients such as chamomile tea, leafy green vegetables, and foods rich in omega-3 fatty acids. Keep the menu nutritionally balanced and easy to cook.”

“User is feeling sadness. Suggest low-cost foods, snacks, and simple leisure activities that could brighten the user's mood, within a budget of 3,000 yen. Consider that the user enjoys chocolate and hot drinks.”

By representing emotional constraints as structured rule entries and mapping them to prompt modifications, the server implements a non-conventional processing flow different from human intuition alone. The server repeatedly updates rule entries based on accumulated feedback, enabling gradual improvement in alignment between emotional states and generated outputs. This feedback loop reduces the need for manual fine-tuning of model prompts and leads to more efficient utilization of model inference resources.

The server also generates integrated purchase candidate information to bridge menu generation and ordering. The server aggregates ingredient information across multiple days and meals into a single list of items. The server converts textual ingredient names into canonical item identifiers using a mapping table. The server sums required quantities per item and normalizes them to sales units, such as kilograms, packs, or bottles. The server stores this information as purchase candidate information in the database. The server then retrieves discount information and special sale information from an external distribution information processing apparatus via an application programming interface. The server applies this information to adjust item selections and quantities to minimize cost while maintaining nutritional constraints. For instance, if two equivalent ingredients are available and one is on special sale, the server can replace the more expensive ingredient with the discounted one as long as the nutrient component information remains within acceptable bounds. Because the server stores ingredient identifiers, quantities, nutrient vectors, and discount data in structured tables, the server can apply algorithmic optimization methods. The server can define an objective function that balances total cost, nutritional deviation, and user preference penalties. The server can use heuristic search or linear programming solvers to select a set of purchase items that minimizes the objective. This structured optimization reduces computational redundancy compared to naive item selection and leads to more efficient network communication with external distribution information processing apparatuses because only a finalized, optimized purchasing plan is transmitted.

The terminal presents the cooking menu information, merchandise information, service information, discount information, and delivery information to the user via a graphical user interface. The user can refine the selections by editing menus or items. The terminal transmits editing operation information to the server. The server applies these edits to update the structured menu and purchase candidate information. When edits occur, the server does not recompute all data from scratch. Instead, the server computes incremental differences in ingredient quantities and updates only affected nutrient aggregation and purchase selection. This incremental update strategy reduces CPU time and database I/O compared to full recomputation, improving responsiveness.

The server then communicates finalized purchase list information to an external distribution service information processing apparatus. The server generates a request message containing normalized item identifiers, quantities, delivery address, and time slot information. The server sends the message over a secure network channel. The distribution service system processes the request and responds with delivery information including delivery timing and tracking identifiers. The server stores this delivery information and provides it to the terminal for display. By automating normalization of purchase list information and mapping it to external distribution formats, the system reduces errors caused by manual entry and ensures that menu generation is tightly coupled with actual physical delivery of ingredients.

The described configuration yields several technical effects in the computing environment. Because the server uses structured numeric data structures, vectorized operations, and closed-loop interactions between generative AI model outputs and numeric evaluation, the system reduces the number of times menus must be regenerated to satisfy constraints. By storing economic, nutritional, emotional, and commercial data in unified schemas and by reusing intermediate results during incremental updates, the server reduces memory duplication and database access overhead. The architecture reduces network load between the server and the terminal because only high-level decisions and incremental updates are transmitted, rather than full raw datasets. The use of multi-modal emotion estimation and rule-based integration of emotional constraints into prompt sentences improves precision of personalization while reducing wasteful model calls. These optimizations constitute improvements to the functioning of the information processing system itself, rather than mere automation of human budgeting steps.

Alternative embodiments are also possible. The server can use different machine learning architectures for the generative AI model, such as a sequence-to-sequence recurrent neural network, a convolutional sequence model, or a mixture of expert models. The server can implement the emotion estimation model as a single transformer encoder operating on synchronized audio and visual embeddings. The database can be implemented as a document-oriented store instead of a relational database, with equivalent schemas represented as nested documents. The optimization of purchase candidate information can use integer linear programming, greedy heuristics, or reinforcement learning-based policies. The terminal can be a wearable device or a home appliance display rather than a smartphone. In any of these variants, the server remains configured to calculate food budget information, construct and refine prompt sentence information for a generative AI model, evaluate and adjust generated cooking menu information using structured nutrient component information, vary generation based on emotional state information, and generate integrated purchase candidate information with discount application and ordering capabilities.

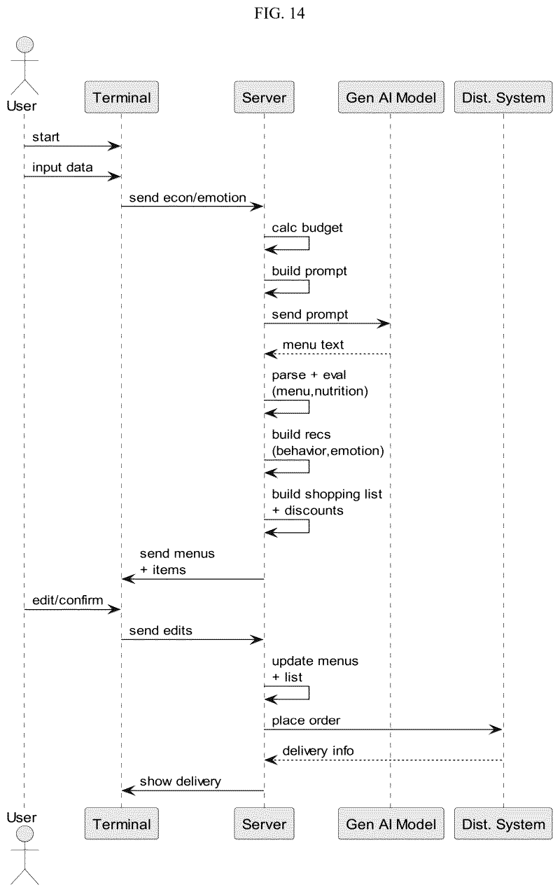

The following describes the processing flow using FIG. 14.

### Step 1:

User operates the terminal to start a budgeting and menu-planning session.

Terminal displays an input screen and receives income values, fixed cost values, and household composition data from the user as input.

Terminal validates the input locally (for example, checks that values are numeric and non-negative) and then outputs a structured request message containing the economic information and household composition information to the server over a network connection.

### Step 2:

Server receives the economic information and household composition information from the terminal as input.

Server stores the received values in a database table as separate fields (user ID, income, fixed costs, number of adults, number of children).

Server outputs a stored economic record that is available for subsequent budget calculation processing.

### Step 3:

Server uses the stored income, fixed costs, and household composition as input to a budget calculation module.

Server performs data processing by converting the values into numerical arrays, subtracting fixed costs from income to compute disposable income, and applying allocation coefficients based on household size to calculate monthly and daily food budget values. Server outputs food budget information including at least a monthly food budget value and a daily food budget value and writes these values back into the database.

### Step 4:

Terminal obtains emotional input data by using an imaging device and a sound acquisition device to capture image information and audio information of the user.

Terminal preprocesses the raw signals (for example, cropping the face region and normalizing audio volume) and outputs the processed image information and audio information to the server.

### Step 5:

Server receives the image information and audio information as input to an emotion estimation model.

Server performs data processing by extracting feature vectors from the image (for example, via convolutional filters) and from the audio (for example, via time-series feature extraction and recurrent processing), concatenating these vectors, and classifying them into one of multiple emotional state categories using a trained neural network.

Server outputs emotional state information including at least an emotional label (such as stress, joy, or sadness) and a confidence score and stores this information in an emotional state table associated with the user.

### Step 6:

Server retrieves food budget information, household composition information, nutrition constraints, and emotional state information from the database as input to a prompt construction module.

Server performs data processing by selecting a prompt template, inserting numeric budget values, number of persons, duration, and emotional-state-dependent ingredient or cooking conditions into placeholder positions, and concatenating these components into a coherent natural-language text string.

Server outputs prompt sentence information that encodes all relevant constraints as a single natural-language instruction.

### Step 7:

Server sends the prompt sentence information as input to the generative AI model.

Server converts the prompt sentence into token identifiers, applies an embedding layer, multiple attention layers, and output layers of the transformer-based language model, and performs decoding based on output probabilities to generate a sequence of tokens representing menus and ingredients.

Server outputs generated text, and then performs parsing operations on that text (for example, detecting day markers, meal labels, and ingredient lines) to convert it into structured cooking menu information and ingredient information, which are stored in menu-related tables in the database.

### Step 8:

Server takes ingredient information as input and queries an internal or external nutrient database for matching ingredient identifiers.

Server performs data processing by mapping human-readable ingredient names to canonical identifiers, retrieving numeric nutrient vectors (for example, energy, protein, fat, carbohydrate, vitamins, minerals) per unit, and multiplying these vectors by the required quantities of each ingredient.

Server outputs aggregated nutrient component information per dish, per meal, and per day and stores these nutrient summaries in association with the corresponding menu records.

### Step 9:

Server uses the aggregated nutrient component information and predefined nutritional reference ranges as input to a nutritional evaluation module.

Server performs data processing by comparing each aggregated nutrient vector to a target vector and computing deviation values (for example, percentage over or under recommended intake) for each nutrient dimension.

Server outputs evaluation results containing deviation scores and flags indicating whether any nutrients exceed or fall below thresholds and records these evaluation results linked to the menu entries.

### Step 10:

Server uses the nutritional evaluation results as input to a prompt refinement module.

Server performs data processing by analyzing which nutrients violate thresholds, selecting appropriate textual constraints (such as “reduce sodium” or “increase vegetables”), and appending or replacing sentence segments in the existing prompt sentence information to encode the required corrections.

Server outputs modified prompt sentence information that explicitly incorporates nutritional adjustments, and optionally re-invokes the generative AI model with the modified prompt to produce updated cooking menu information and ingredient information.

### Step 11:

Server retrieves behavior history information, including purchase history information and preference information, together with the current cooking menu information as input to a recommendation module.

Server performs data processing by computing similarity scores between past purchased items and current ingredients, identifying favored categories and disfavored items, and ranking candidate merchandise information and service information related to the menu (for example, alternative brands, cooking aids, or wellness services).

Server outputs a ranked list of merchandise information and service information that are associated with the cooking menu information and tailored to the user's past behavior.

### Step 12:

Server uses emotional state information and the ranked merchandise and service candidates as input to an emotion-aware adjustment module.

Server performs data processing by consulting an internal rule table that maps emotional states to ingredient types, dish styles, or service categories, and filtering or re-ranking merchandise information and service information according to emotional-state-dependent ingredient conditions and cooking conditions.

Server outputs emotion-conditioned recommendations, such as foods for stress relief or uplifting items for sadness, and stores these adjusted recommendations for presentation.

### Step 13:

Server aggregates ingredient information across the generated cooking menu information for a specified period as input to a purchase candidate generation module.

Server performs data processing by summing required quantities of each ingredient, converting units to standardized sales units, and resolving ingredient names to canonical item identifiers used by external distribution systems.

Server outputs integrated purchase candidate information including item identifiers, normalized quantities, and associated menu references and stores this information as a structured record in the database.

### Step 14:

Server uses integrated purchase candidate information as input and queries external or internal sources of discount information and special sale information.

Server performs data processing by matching candidate items to available discounts, computing revised prices, and, where equivalent items exist, substituting higher-cost items with lower-cost alternatives that maintain similar nutrient profiles.

Server outputs updated purchase candidate information enriched with discount information and special sale information, along with cost summaries per period.

### Step 15:

Server receives a display request from the terminal and takes cooking menu information, merchandise information, service information, discount information, and delivery-related placeholders as input to a presentation preparation module.

Server performs data processing by organizing menus by day and meal, grouping related products and services, and packaging the information into a response structure suitable for the terminal's user interface.

Server outputs a presentation dataset that the terminal can render as lists, cards, or calendar views.

### Step 16:

Terminal receives the presentation dataset as input and displays the cooking menu information, recommended merchandise and services, and discount information to the user. User interacts with the terminal to accept, reject, or modify specific dishes and items, and the terminal records these operations as editing operation information.

Terminal outputs the editing operation information to the server as a structured message indicating which menus or items have been altered, added, or removed.

### Step 17:

Server uses the editing operation information and existing menu and purchase candidate records as input to an incremental update module.

Server performs data processing by identifying affected menu entries, recalculating only the changed ingredient quantities, updating associated nutrient aggregations and cost summaries, and adjusting purchase candidate information accordingly without recomputing unaffected parts.

Server outputs updated cooking menu information, ingredient information, nutrient summaries, and purchase candidate information reflecting the user's edits.

### Step 18:

Server takes finalized purchase candidate information as input to a purchase list generation module.

Server performs data processing by formatting item identifiers and normalized quantities into a purchase list structure required by an external distribution service information processing apparatus and attaching user delivery address and preferred delivery time information.

Server outputs purchase list information and stores an order draft associated with the user.

### Step 19:

User confirms the purchase on the terminal, and the terminal sends an order confirmation message referencing the order draft to the server as input.

Server uses the order draft and confirmation as input to a communication module that interacts with the external distribution service information processing apparatus. Server performs data processing by authenticating with the external apparatus, transmitting the purchase list information, and receiving delivery information including scheduled delivery times and tracking identifiers.

Server outputs finalized delivery information, updates order status records in the database, and returns the delivery information to the terminal for user notification.

### Step 20:

Server uses post-delivery feedback information and corresponding cooking menu information, nutrient summaries, and emotional state history as input to a learning and adaptation module.

Server performs data processing by correlating user satisfaction scores and subsequent emotional states with specific menu patterns and recommendation choices, updating internal weights or rule parameters used for preference estimation and emotional state mapping, and optionally fine-tuning prompt construction heuristics.

Server outputs updated model parameters, updated rule tables, and revised prompt construction strategies, which are used to improve accuracy, response time, and personalization in subsequent executions of the generative AI model and related modules.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

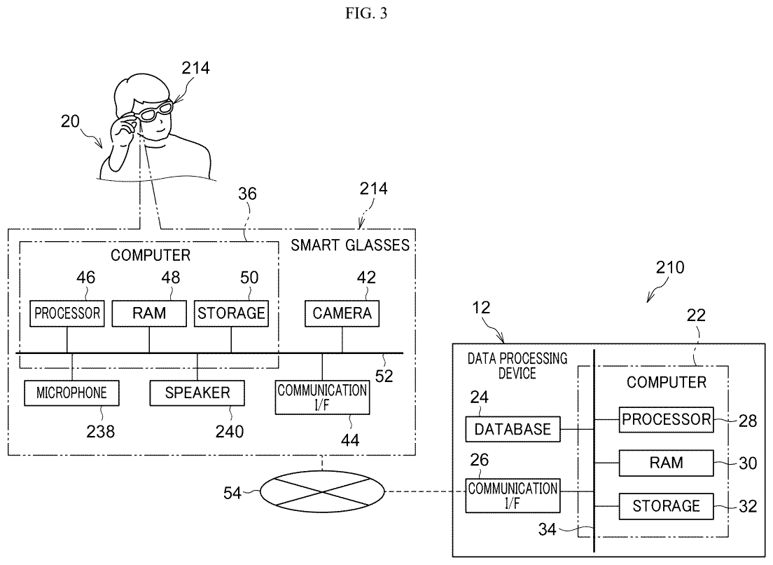

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

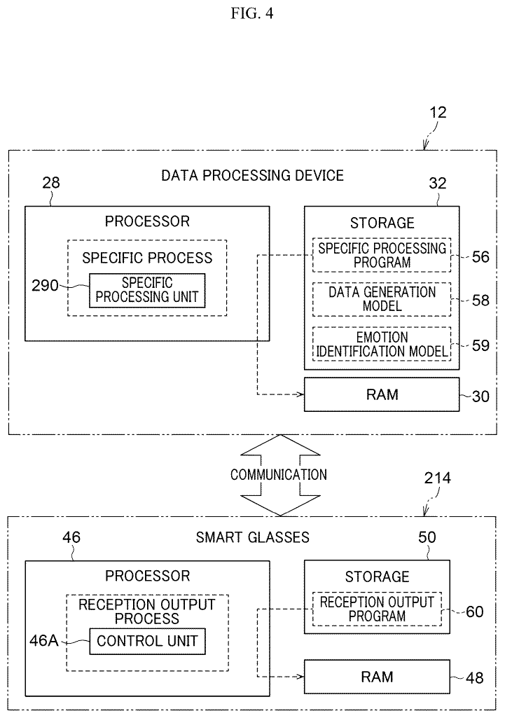

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

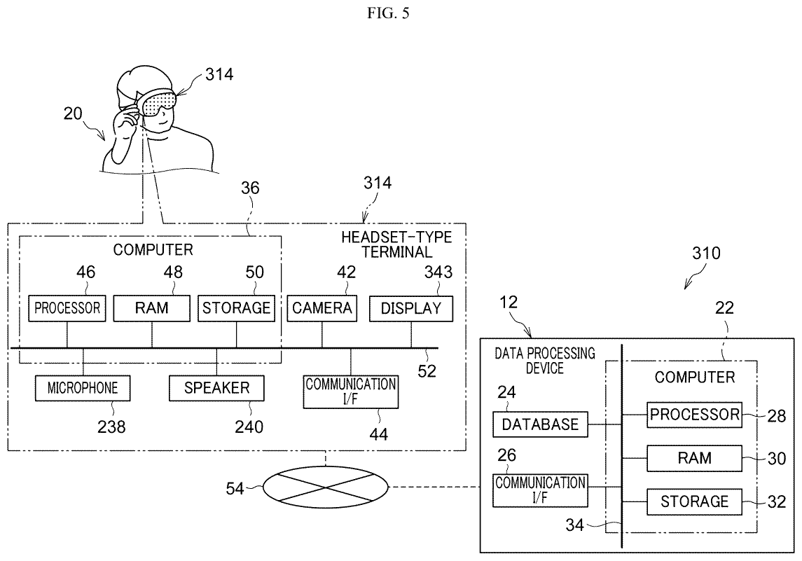

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

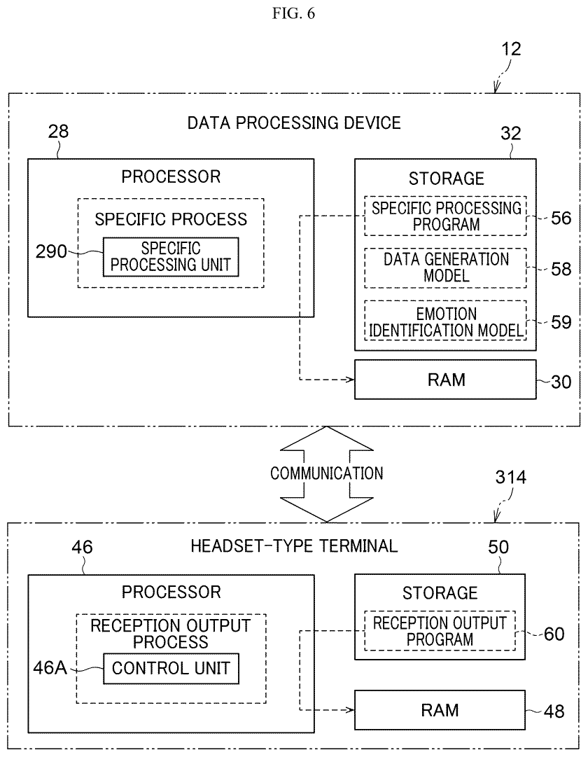

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

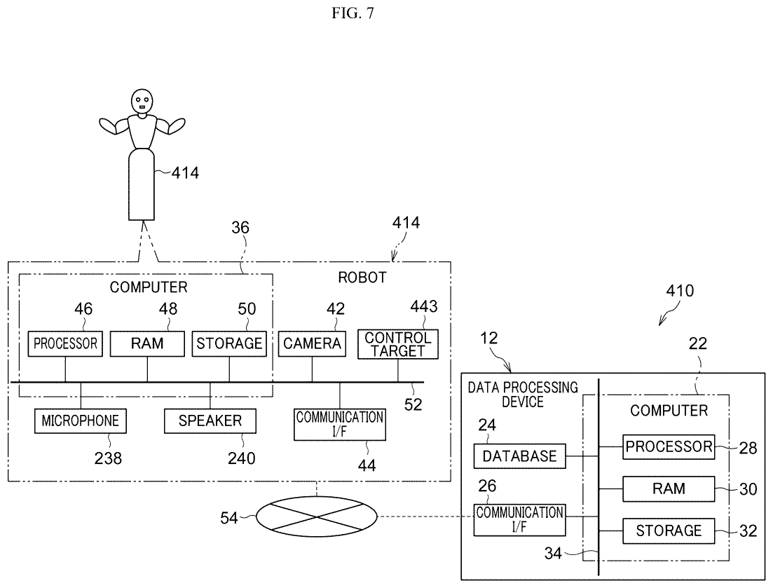

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

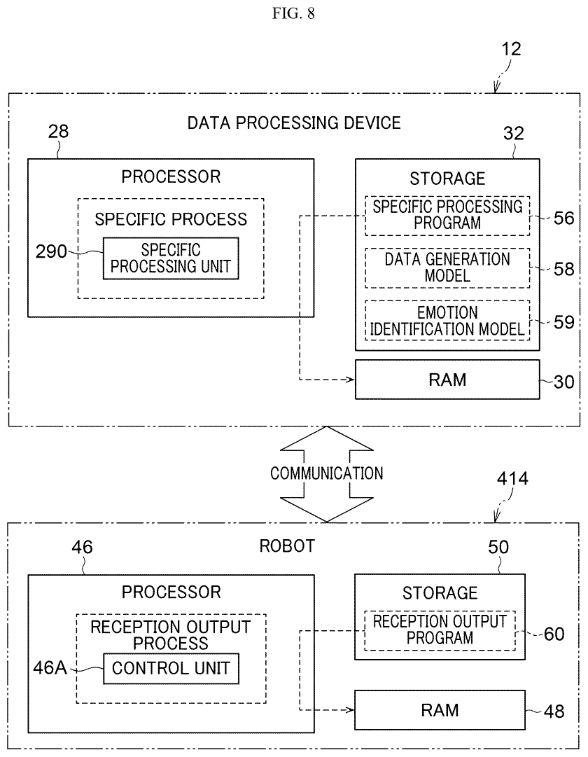

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

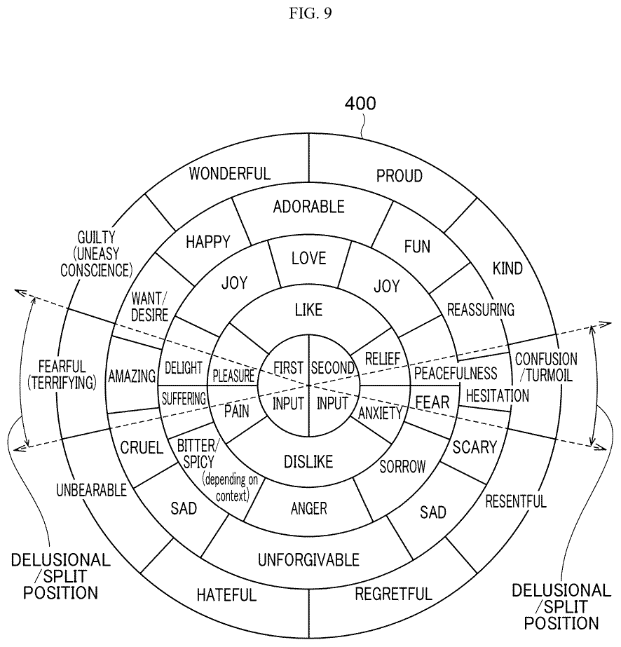

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

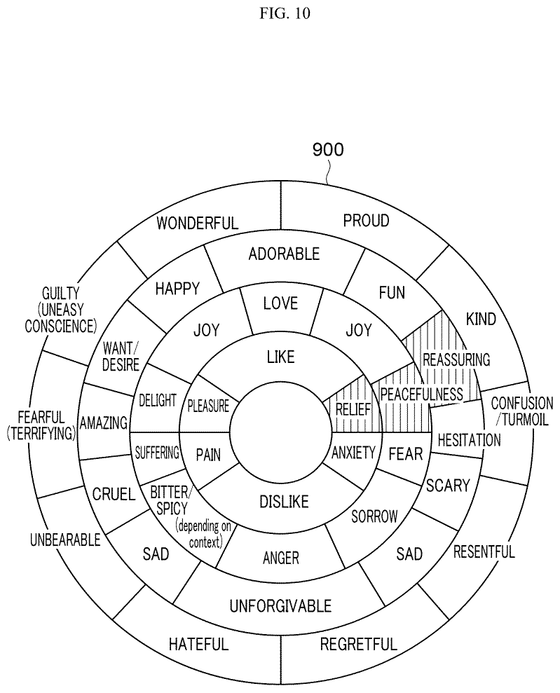

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire user economic information and household information from a terminal device and store the acquired information in a storage device,
extract income information, expenditure information, and household composition information of the user from the stored information, calculate disposable funds by subtracting the expenditure information from the income information using a numerical computation program and a tabular data processing program, calculate food budget information based on the disposable funds and the household composition information, and store the food budget information in the storage device,
generate a prompt sentence to be input to a generative information processing model based on the food budget information, the household composition information, and preference information and health orientation information acquired from the user,
input the prompt sentence to the generative information processing model to cause the generative information processing model to generate home-cooking menu information that satisfies nutritional conditions and health conditions within a range of the food budget information, analyze a generation result, and store structured menu information by day and by meal category as the home-cooking menu information in the storage device,
acquire financial account information and payment instrument information from the user, obtain transaction history information from an external information processing apparatus via a communication function using the financial account information and the payment instrument information, extract and aggregate dining-related transaction history by using the tabular data processing program to generate historical food expenditure information, update the food budget information based on the historical food expenditure information, and regenerate the prompt sentence and the home-cooking menu information based on the updated food budget information,
acquire evaluation information and preference change information from the user regarding the home-cooking menu information and proposed goods and proposed services, and update generation conditions of the prompt sentence and generation conditions of the home-cooking menu information in a learning manner based on the evaluation information and the preference change information, and
select goods and services related to the home-cooking menu information based on purchase history information of the user and the preference information, and present proposal information including the selected goods and services to the user.

### Supplementary 2

The system according to supplementary 1,
wherein the processor is configured to acquire emotional state information of the user and adjust content of the prompt sentence and content of the proposal information based on the emotional state information.

### Supplementary 3

The system according to supplementary 1,
wherein the processor is configured to transmit ingredient information included in the home-cooking menu information to an external delivery information processing apparatus via a communication function, generate delivery request information based on the ingredient information, and enable the user to obtain food ingredients corresponding to the ingredient information.

### Application Example 1

### Supplementary 1

A system comprising a processor,
wherein the processor is configured to
acquire numerical information and attribute information related to a user's income, fixed expenditures, and household composition, and store the acquired information as record information in a storage unit,
process the record information by using a numerical computation program that performs matrix operations or array operations to calculate a disposable income, and numerically calculate a food expense budget by applying a predetermined ratio or coefficient to the disposable income based on the household composition,
generate a natural language prompt sentence including the food expense budget and the record information, input the prompt sentence as input data to a generative AI model, and cause the generative AI model to generate home-cooking menu information and ingredient information corresponding to the menu information within a range of the food expense budget while taking nutritional balance into account,
analyze text data output from the generative AI model, extract the text data as structured data including at least a menu name, date information or period information, ingredient name, quantity, unit, and cost estimation information, and store the structured data as stored information in the storage unit,
transmit, to a user terminal, display data representing a plurality of menu candidates based on the structured data, receive identification information corresponding to a selected menu candidate from the user terminal, and generate a purchase candidate list by aggregating ingredient information included in the selected menu candidate and integrating quantities for each identical ingredient by aggregation processing,
convert the purchase candidate list into a predetermined data format compatible with a communication interface provided by an information processing apparatus of a delivery service, transmit order information including the purchase candidate list to the information processing apparatus of the delivery service in accordance with a communication protocol, receive an order acceptance result and delivery schedule information from the information processing apparatus of the delivery service, and notify the user terminal of the order acceptance result and the delivery schedule information, and
acquire and store purchase history information, preference information, and emotional state information of the user, and generate proposal information by adjusting content of presentation of the home-cooking menu information or product information and service information based on the purchase history information, the preference information, and the emotional state information.

### Supplementary 2

The system according to supplementary 1,
wherein the processor is configured to
estimate the emotional state information of the user based on utterance information, input character information, or operation history information acquired from the user terminal, modify wording or constraint conditions of the prompt sentence in accordance with the emotional state information, and change content of presentation by filtering or weighting a candidate set of the home-cooking menu information or the product information and the service information generated by the generative AI model.

### Supplementary 3

The system according to supplementary 1,
wherein the processor is configured to
acquire product identification information and inventory information from the information processing apparatus of the delivery service, update ingredient information in the purchase candidate list by associating the ingredient information with product information available in the delivery service, generate and transmit order information including the updated product information, and sequentially notify the user terminal of an order status and a delivery status in the delivery service.

### Example 2

### Supplementary 1

A system comprising a processor,
wherein the processor is configured to
receive, from a communication terminal, user economic information and household information, the user economic information including income and expenditure, and the household information including a number of household members, and store the received information in a storage device,
perform an arithmetic operation based on the income and the expenditure included in the user economic information to calculate a food budget available for meals, and store the calculated food budget as budget information in the storage device,
generate, based on the food budget and the household information, a prompt sentence expressed in a natural language, the prompt sentence including at least a condition related to the food budget and a condition related to the number of household members, and input a request including the prompt sentence to a generative AI model so as to cause the generative AI model to generate home-cooked menu information that takes nutritional balance and cost constraints into account,
extract ingredient information from the generated home-cooked menu information, search an information storage apparatus or an external information providing apparatus storing sales information corresponding to the ingredient information, and acquire household-burden-reduction product information and service information including at least one of price information, discount information, and sales promotion information related to the ingredient information,
estimate, based on the food budget and the household-burden-reduction product information and service information, an expected total cost for the generated home-cooked menu information over an entire menu or over a predetermined period, determine whether the expected total cost falls within the food budget, and append a determination result to the home-cooked menu information, and
integrate the home-cooked menu information, the household-burden-reduction product information and service information, and the determination result into presentation information, and transmit the presentation information to the communication terminal.

### Supplementary 2

The system according to supplementary 1,
wherein the processor is configured to
include, in the prompt sentence input to the generative AI model, at least one of user preference information and user health condition information, and thereby adapt content of the home-cooked menu information to at least one of a user preference and a user health condition.

### Supplementary 3

The system according to supplementary 1,
wherein the processor is configured to
generate order information that enables batch ordering, to a delivery service, of items
corresponding to the ingredient information contained in the home-cooked menu information and the household-burden-reduction product information, and transmit the order information to the communication terminal.

### Application Example 2

### Supplementary 1

A system comprising a processor,
wherein the processor is configured to
acquire economic information of a user, and calculate food budget information allowable for the user on the basis of income information, fixed cost information, and household composition information of the user,
generate prompt sentence information expressed in a natural language on the basis of the food budget information and the household composition information, input the prompt sentence information to a generative AI model, and cause the generative AI model to generate cooking menu information that is nutritionally balanced within a range of the food budget information, together with ingredient information corresponding to the cooking menu information,
acquire nutrient component information corresponding to the ingredient information from an external information source or stored information, evaluate nutritional balance of the cooking menu information on the basis of the nutrient component information, and automatically modify the prompt sentence information or the cooking menu information in accordance with an evaluation result,
acquire behavior history information of the user, and select merchandise information or service information related to the cooking menu information on the basis of purchase history information and preference information included in the behavior history information,
acquire emotional state information of the user, and add, in accordance with the emotional state information, emotional-state-dependent ingredient conditions or cooking conditions to the prompt sentence information and re-input the prompt sentence information to the generative AI model so as to cause the generative AI model to generate, in accordance with the emotional state, the cooking menu information and the merchandise information or the service information,
create integrated purchase candidate information for a plurality of periods on the basis of the cooking menu information and the ingredient information, add discount information and special sale information to the purchase candidate information, and, via a communication function of a distribution information processing apparatus, place the ingredient information in an orderable state, and
output, via a user interface, the cooking menu information, the merchandise information, the service information, the discount information, and delivery information, and partially update the prompt sentence information and the cooking menu information in accordance with editing operation information from the user.

### Supplementary 2

The system according to supplementary 1,
wherein the processor is configured to
obtain the emotional state information by using an emotion estimation model that performs emotion estimation processing with image information and audio information acquired from an imaging device and a sound acquisition device as inputs, store the emotional state information as history information for each user, and update, in a learning manner on the basis of the history information, the emotional-state-dependent ingredient conditions or cooking conditions in the prompt sentence information.

### Supplementary 3

The system according to supplementary 1,
wherein the processor is configured to
aggregate required quantity information for each ingredient on the basis of the cooking menu information and the ingredient information, generate purchase list information normalized to predetermined sales units, and execute communication processing to an external distribution service information processing apparatus on the basis of the purchase list information so as to have articles corresponding to the ingredient information delivered to a location designated by the user.

What is claimed is:

1. A system comprising:
circuitry configured to:
acquire, via a communication interface coupled to a packet-switched network, first numerical parameter data and second numerical parameter data from a terminal device;
compute a constraint boundary value by executing a numerical computation operation on the first numerical parameter data and the second numerical parameter data, the numerical computation operation comprising a subtraction operation and a proportional apportionment operation based on stored weighting coefficients;
construct a constrained instruction sequence comprising the constraint boundary value and preference parameter data acquired from the terminal device, and input the constrained instruction sequence into a generative neural network model comprising a transformer-based architecture to generate candidate output data satisfying constraint conditions derived from the constraint boundary value;
acquire external record data from an external information processing apparatus via the communication interface, extract category-classified records from the external record data using a structured data processing operation, compute aggregated numerical values from the category-classified records, and update the constraint boundary value based on a deviation between the aggregated numerical values and the constraint boundary value;
reconstruct the constrained instruction sequence based on the updated constraint boundary value and input the reconstructed constrained instruction sequence into the generative neural network model to generate updated candidate output data; and
transmit the updated candidate output data to the terminal device via the communication interface.

2. The system according to claim 1, wherein the circuitry is further configured to:
parse the first numerical parameter data to extract monthly revenue values and a plurality of expenditure category values from the second numerical parameter data, compute a disposable value as a difference between a sum of the monthly revenue values and a sum of the expenditure category values, and compute the constraint boundary value by applying a weighting function based on a number of household members and age category indicators included in household composition data acquired from the terminal device.

3. The system according to claim 2, wherein the circuitry is further configured to:
filter the external record data by date range and category identifier to extract the category-classified records, compute the aggregated numerical values as a sum of transaction amounts within the category-classified records for each time period, and compute a deviation value between the aggregated numerical values and the constraint boundary value.

4. The system according to claim 3, wherein the circuitry is further configured to:
adjust the stored weighting coefficients based on the deviation value by applying a correction factor proportional to a magnitude of the deviation value, store the adjusted weighting coefficients in an information storage device, and use the adjusted weighting coefficients in subsequent computations of the constraint boundary value.

5. The system according to claim 4, wherein the constrained instruction sequence further comprises:
a constraint specification derived from the constraint boundary value specifying a maximum cost parameter, a nutritional balance parameter derived from household composition data, and a preference exclusion list derived from the preference parameter data, the constraint specification formatted as structured control conditions for the generative neural network model.

6. The system according to claim 1, wherein the circuitry is further configured to:
parse the candidate output data generated by the generative neural network model into structured plan records, each structured plan record comprising a time slot identifier, a plan segment identifier, component item identifiers, quantity values, estimated cost values, and attribute values, and store the structured plan records in an information storage device.

7. The system according to claim 6, wherein the circuitry is further configured to:
select related resource items from an item database stored in the information storage device based on the component item identifiers in the structured plan records and purchase history data associated with the first numerical parameter data, compute relevance scores for the related resource items, rank the related resource items by the relevance scores, and generate proposal data comprising the ranked related resource items for transmission to the terminal device.

8. The system according to claim 7, wherein the circuitry is further configured to:
acquire affective state data of the user from the terminal device, classify the affective state data into an affective state category using a neural network classifier, and adjust at least one of the constrained instruction sequence and the proposal data based on the affective state category by modifying constraint parameters or re-ranking the related resource items according to affective-state-conditioned weighting values.

9. The system according to claim 1, wherein the generative neural network model comprises:
an embedding layer configured to convert input tokens into embedding vectors, a positional encoding module, a plurality of transformer layers each comprising multi-head self-attention and feed-forward sublayers with layer normalization, and a decoding stage configured to generate a probability distribution over a vocabulary and select output tokens using a sampling strategy.

10. The system according to claim 9, wherein the circuitry is further configured to:
set inference parameters for the generative neural network model comprising a temperature value, a maximum token count, and a sampling strategy selection, and adjust the inference parameters based on a complexity metric derived from a number of constraint conditions in the constrained instruction sequence.

11. The system according to claim 1, wherein the circuitry is further configured to:
acquire evaluation data from the terminal device indicating user acceptance or rejection of individual plan segments within the candidate output data, and update generation condition parameters for the constrained instruction sequence based on the evaluation data to increase a probability of generating plan segments similar to accepted plan segments and decrease a probability of generating plan segments similar to rejected plan segments in subsequent generation cycles.

12. The system according to claim 11, wherein the circuitry is further configured to:
maintain a preference model in the information storage device, the preference model comprising weighted preference vectors for attribute categories, update the weighted preference vectors based on the evaluation data by increasing weights for attribute values associated with accepted plan segments and decreasing weights for attribute values associated with rejected plan segments, and incorporate the updated weighted preference vectors into the constrained instruction sequence.

13. The system according to claim 1, wherein the circuitry is further configured to:
validate the candidate output data by verifying that each structured plan record satisfies the constraint conditions derived from the constraint boundary value including a total cost not exceeding the constraint boundary value and attribute values conforming to the nutritional balance parameter, and when a plan record violates a constraint condition, construct a correction instruction sequence specifying the violated constraint and re-input the correction instruction sequence into the generative neural network model to obtain corrected candidate output data.

14. The system according to claim 6, wherein the circuitry is further configured to:
extract the component item identifiers and quantity values from the structured plan records, transmit an order request comprising the component item identifiers and the quantity values to a fulfillment service apparatus via the communication interface, receive order confirmation data from the fulfillment service apparatus, and store the order confirmation data in association with the structured plan records in the information storage device.

15. The system according to claim 1, wherein the circuitry is further configured to:
acquire the external record data from a plurality of external information processing apparatuses each associated with a different financial account or payment instrument, normalize the external record data from the plurality of sources into a unified record format, and compute the aggregated numerical values from the normalized external record data.

16. The system according to claim 1, wherein the circuitry is further configured to:
execute the numerical computation operation on a periodic schedule to recompute the constraint boundary value based on updated first numerical parameter data and second numerical parameter data acquired from the terminal device and updated aggregated numerical values derived from newly acquired external record data, and automatically regenerate the candidate output data upon each recomputation.

17. The system according to claim 6, wherein the constraint boundary value represents a food budget, the candidate output data comprises a home-cooked meal menu organized by day and meal category, the component item identifiers identify food ingredients, the preference parameter data includes dietary restrictions and health orientation information, the proposal data comprises recommended food products and cooking-related services, and the fulfillment service apparatus provides a grocery delivery service.

18. A system comprising:
circuitry configured to:
acquire first numerical parameter data and second numerical parameter data from a terminal device via a communication interface;
compute a constraint boundary value by a numerical computation operation based on the first numerical parameter data and the second numerical parameter data;
construct a constrained instruction sequence comprising the constraint boundary value and preference parameter data, and input the constrained instruction sequence into a generative neural network model to generate candidate output data satisfying constraint conditions;
acquire external record data from an external information processing apparatus, compute aggregated numerical values, update the constraint boundary value based on the aggregated numerical values, and regenerate the candidate output data; and
transmit the candidate output data to the terminal device.

19. The system according to claim 18, wherein the circuitry is further configured to:
acquire affective state data of the user, classify the affective state data into an affective state category, and adjust the constrained instruction sequence based on the affective state category to modify the candidate output data.

20. A method comprising:
acquiring, by circuitry via a communication interface coupled to a packet-switched network, first numerical parameter data and second numerical parameter data from a terminal device;
computing a constraint boundary value by executing a numerical computation operation on the first numerical parameter data and the second numerical parameter data, the numerical computation operation comprising a subtraction operation and a proportional apportionment operation based on stored weighting coefficients;
constructing a constrained instruction sequence comprising the constraint boundary value and preference parameter data acquired from the terminal device, and inputting the constrained instruction sequence into a generative neural network model comprising a transformer-based architecture to generate candidate output data satisfying constraint conditions derived from the constraint boundary value;
acquiring external record data from an external information processing apparatus via the communication interface, extracting category-classified records from the external record data using a structured data processing operation, computing aggregated numerical values from the category-classified records, and updating the constraint boundary value based on a deviation between the aggregated numerical values and the constraint boundary value;
reconstructing the constrained instruction sequence based on the updated constraint boundary value and inputting the reconstructed constrained instruction sequence into the generative neural network model to generate updated candidate output data; and
transmitting the updated candidate output data to the terminal device via the communication interface.
